(19) United States
(12) Patent Application Publication
(10) Pub. No.: US 2026/0088881 A1
(43) Pub. Date: Mar. 26, 2026

(54) METHODS, ARCHITECTURES, APPARATUSES AND SYSTEMS FOR PROACTIVE NON-RADIO MEASUREMENTS BASED BEAM RECOVERY PROCEDURE

(71) Applicant: InterDigital Patent Holdings, Inc., Wilmington, DE (US)

(72) Inventors: Umer Salim, Vallauris (FR); Pascal Adjakple, Great Neck, NY (US); Ravikumar Pragada, Warrington, PA (US)

(21) Appl. No.: 19/109,455

(22) PCT Filed: Aug. 31, 2023
(86) PCT No.: PCT/US2023/031607

§ 371 Date: Mar. 6, 2025

Related U.S. Application Data
(60) Provisional application No. 63/403,962, filed on Sep. 6, 2022.

(51) Int. Cl. H04B 7/06; H04W 74/0833

(52) U.S. Cl. CPC H04B 7/06952; H04W 74/0833

(57) ABSTRACT

Procedures, methods, architectures, apparatuses, systems, devices, and computer program products implemented by a Wireless Transmit/Receive Unit (WTRU) comprises: receiving first information indicating a network coverage ensemble area; receiving second information indicating a set of candidate beams and a configuration associated with the set of candidate beams; performing first local sensor measurements; selecting a subset of candidate beams from the set of candidate beams based on the first local sensor measurements and the network coverage ensemble area, responsive to a detection of a beam failure; performing, for each candidate beams, second local sensor measurements and radio measurements; selecting a candidate beam based on criteria associated with the second local sensor measurements and with the radio measurements; determining at least one random access channel (RACH) parameter for the selected candidate beam; and sending RACH transmission on the selected candidate beam using the at least one RACH parameter.

### CROSS-REFERENCE TO RELATED APPLICATIONS

This application claims the benefit of U.S. Patent Application No. 63/403,962 filed Sep. 6, 2022, which is incorporated herein by reference.

### TECHNICAL FIELD

The present disclosure is generally directed to the fields of communications, software and encoding, including, for example, to methods, architectures, apparatuses, systems directed for proactive non-radio measurements based beam failure recovery (BFR).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example WTRU that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a timing diagram of a WTRU (e.g., UE) attach procedure;

FIG. 3 illustrates a beam failure detection procedure at a medium access control (MAC) layer;

FIG. 4 illustrates parallel running procedures for beam/cell level mobility;

FIG. 5 illustrates a beam span configuration;

FIG. 6 illustrates a message sequence diagram for an example of proactive BFR with the WTRU (e.g., UE) determining the beam through coverage ensemble and validation over radio measurements;

FIG. 7 illustrates a message sequence diagram for message exchanges between a WTRU (e.g., UEL) and the network where the WTRU (e.g., UE) is undergoing beam failure;

FIG. 8 illustrates a message sequence diagram for message exchanges between a WTRU (e.g., UE) and the network during a beam failure recovery procedure;

FIG. 9 shows a flow chart for a proactive beam recovery procedure with separate device/external mobility configurations;

FIG. 10 shows a flow chart for proactive beam failure recovery with unified configuration;

FIG. 11 illustrates a beam failure recovery embodiment in translational motion scenario;

FIG. 12 shows a flow chart for a proactive BFR procedure with coverage ensemble as WTRU (e.g., UE) dedicated signaling;

FIG. 13 shows a flow chart for a proactive BFR procedure with coverage ensemble as broadcast signaling;

FIG. 14 is a flow diagram illustrating a method implemented at a WTRU for proactive non-radio measurements based beam failure recovery;

FIG. 15 is a flow diagram illustrating another method implemented at a WTRU for proactive non-radio measurements based beam failure recovery; and

FIG. 16 is a flow diagram illustrating a further method implemented at a WTRU for proactive non-radio measurements based beam failure recovery.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

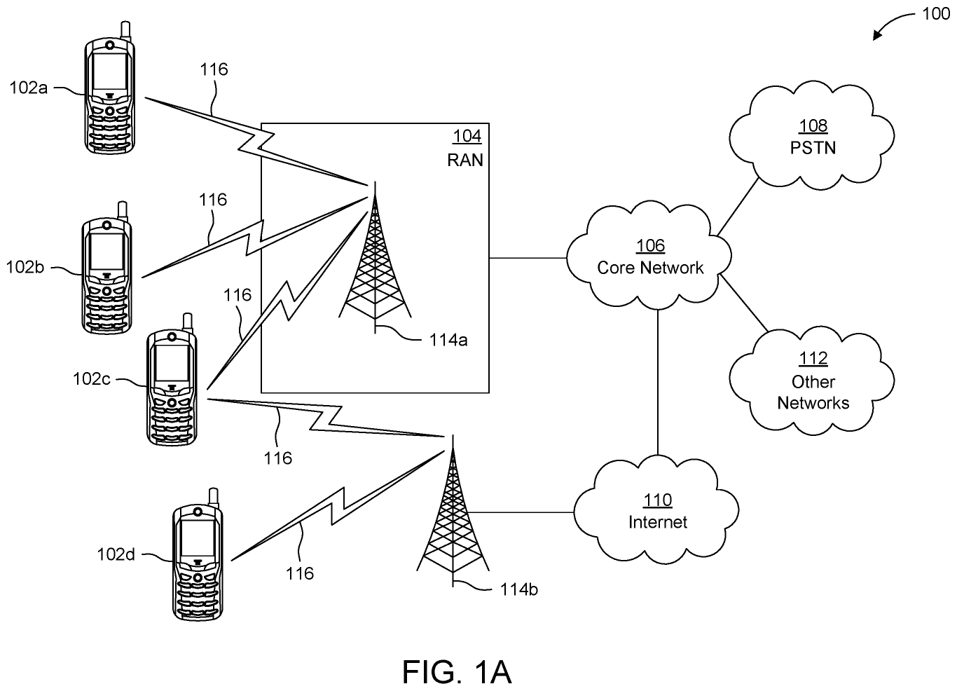

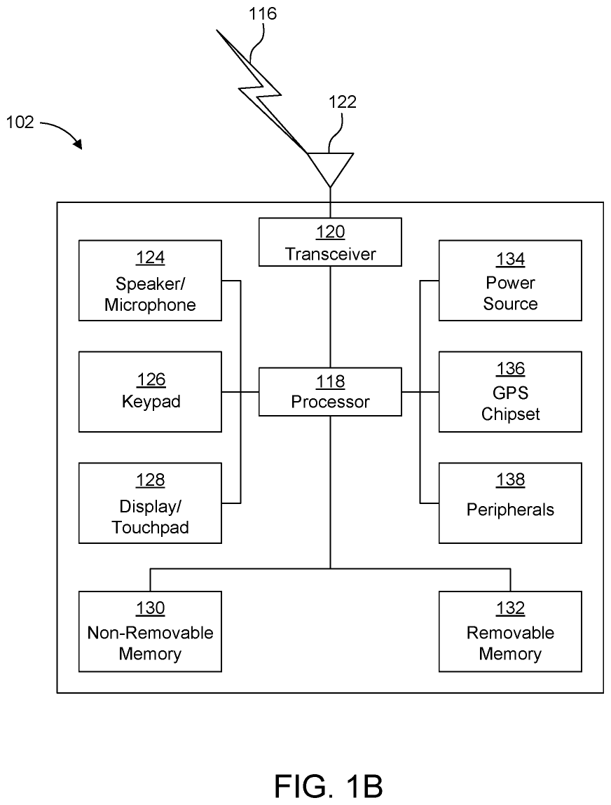

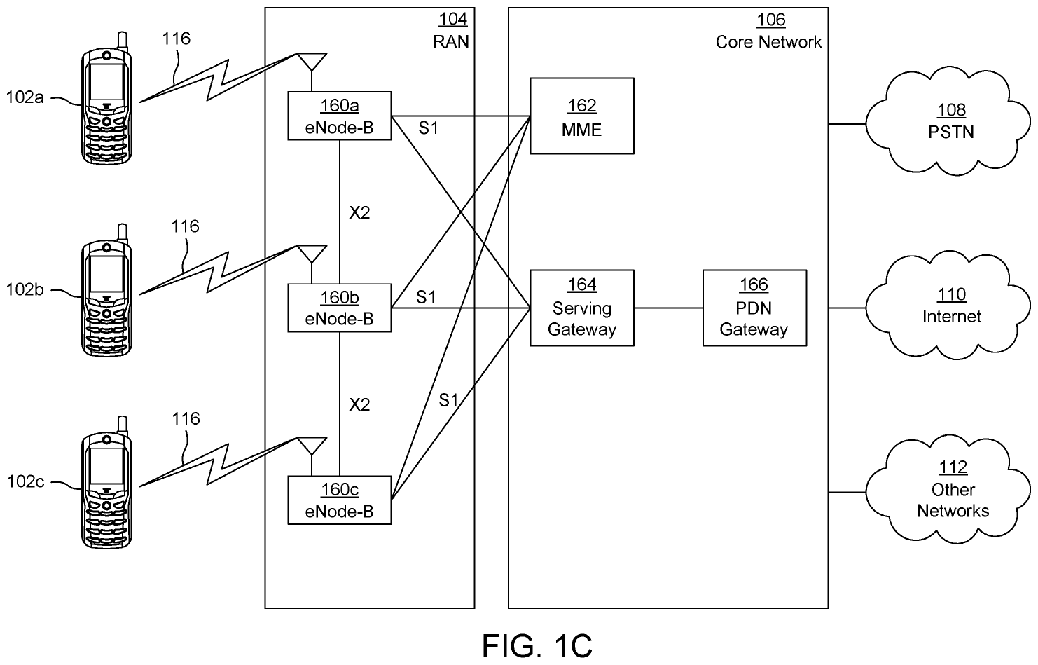

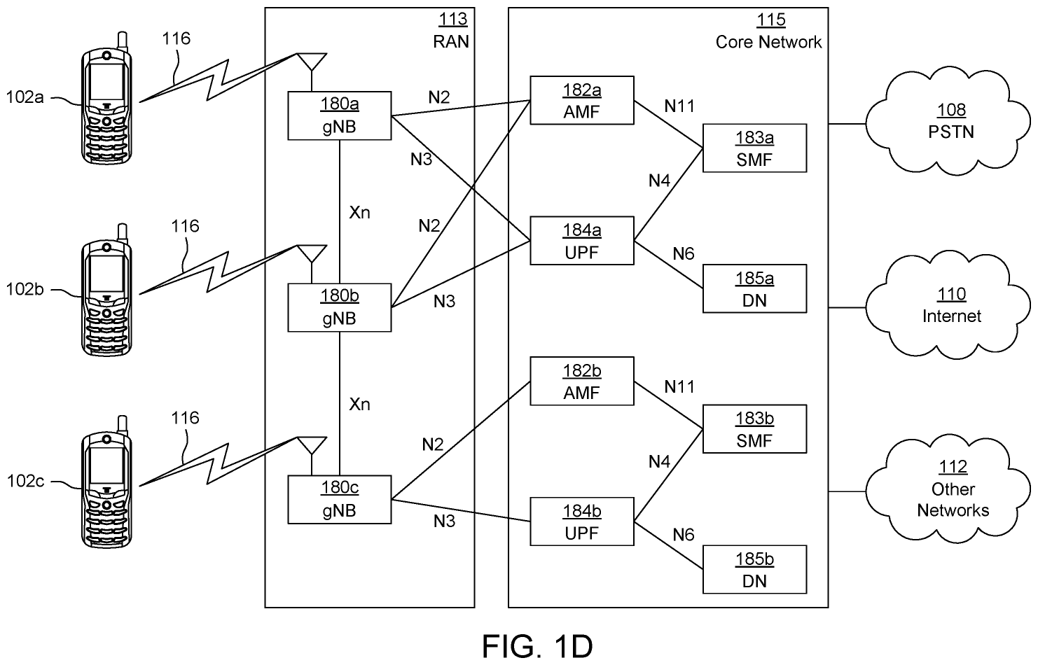

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (IMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU (e.g., UE).

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite.

The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11 af and 802.11 ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

The following disclosure describes methods and procedures for proactive non-radio measurements based beam failure recovery, the methods and procedures may comprise any of the following actions:
A WTRU) (e.g., User equipment (UE)) may provide assistance information to the network about any of: (1) position, (2) location, (3) panels, (4) field of view (FoV), (5) application-quality of service (QoS) from local sensors and measurement data.
A network base station (e.g., a gNode-B) may prepare a proactive beam recovery configuration, for example, in response to the WTRU (e.g., UE) assistance information combined with its knowledge of network deployment and may transmit it to the WTRU (e.g., UE).
The proactive beam recovery configuration may comprise a set of candidate beams for recovery and/or the mapping of these candidate beams to suitable active zones (position/location, angular span, WTRU (e.g., UE) panel) where these beams may be activated with proactive.
After a beam failure event, the WTRU (e.g., UE) may extract the information from local sensors and measurement data to compute its updated geographic coordinates and orientation.
The WTRU (e.g., UE) may identify the suitable beam recovery candidate according to its determined coordinates/orientation.
The WTRU (e.g., UE) may derive the random access channel (RACH) parameters for the selected recovery candidate and may perform RACH transmission as part of the beam recovery procedure on the selected candidate beam.

### 5G NR—Beam Based Procedures

A key feature of the 5G-New Radio (NR) design is its ability to operate in two different frequency ranges: sub-6 GHz which is called frequency range 1 (FR1) and millimeter wave (mmWave) termed as frequency range 2 (FR2). As the availability of sub-6 GHz range becomes more limited, mmWave frequency bands with wider bandwidths will become more predominant. This led to the extension of FR2 range to 71 GHz in 3GPP Release-17, and the extended range between 51.4 GHz to 71 GHz is termed as FR2-2.

3GPP 5G NR standards define new Physical Layer (PHY) and Medium Access Control (MAC) layer features to support directional communications. Among the important features is beam management, which is used to acquire and maintain beams. It also defines new initial access procedures to ensure successful directional transmission. As the transmission and reception are happening through narrow beams, there are procedures to detect beam failure and to recover from beam failure.

### Beam Management

Beam management is a set of Layer 1 (PHY) and Layer 2 (MAC) procedures to establish and retain an optimal beam pair for good connectivity. A beam pair may comprise a transmit beam and a corresponding receive beam in one link direction.

Before a WTRU (e.g., UE) can communicate with the network, it may perform cell search and selection procedures and obtain initial cell synchronization and system information. The first step in that process may be acquiring frame synchronization, finding out the cell identity and decoding the MIB and system information block type 1 (SIB1).

In the case of a multi-antenna system that may transmit multiple beams, detecting the beams from network node (e.g., gNB) may be a part of the initial access procedure where the WTRU (e.g., UE) may detect (e.g., all) the beams in the search space.

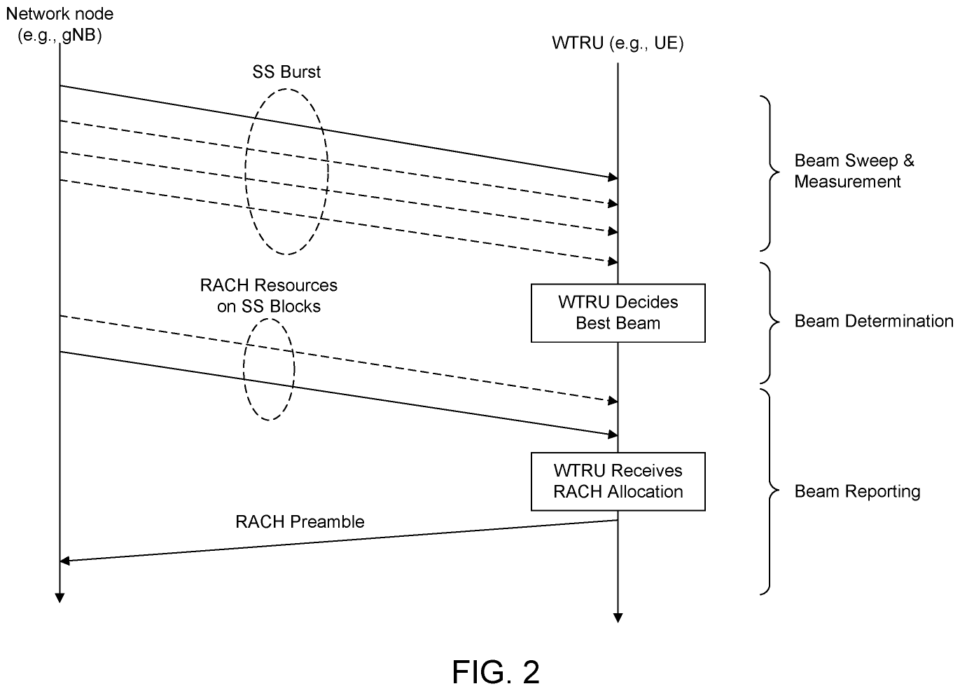

FIG. 2 shows the timing diagram for the WTRU (e.g., UE) attach procedure, which includes various aspects of beam management. The WTRU (e.g., UE) may (e.g., first) find a suitable beam, decode necessary system information through this beam, and (e.g.,) then initiate uplink (UL) connection using the received parameters.

### Beam Sweeping and Initial Access

A network node (e.g., gNB) may transmit beams in all directions in a burst at regular defined intervals. Whenever a WTRU (e.g., UE) is synchronizing with the network, it may read the synchronization signal block (SSB) and extract any of the following:
Primary synchronization signal (PSS):
   One of three possible sequences.
   Provides timing estimate.
Secondary synchronization signal (SSS):
   One of 336 possible sequences.
   Provides cell IID (one of 3*336=1008).
Physical broadcast channel (PBCH) and demodulation reference signal (DMRS):
   Contains master information block (MIB).
   Includes basic information to take the next step, which is to decode the SIB1.

### Beam Measurement and Determination

A WTRU (e.g., UE) may measure the beam strength by measuring received signal power through a beam. In idle mode it may be based on the synchronization signals, and in connected mode it may be based on the channel state information reference signal (CSI-RS) in downlink and sounding reference signal (SRS) in uplink. The WTRU (e.g., UE) may search for the best beam periodically, for example, using the predefined threshold criteria defined by the network node (e.g., gNB) and/or may identify the beam that has highest reference signal received power (RSRP).

### Beam Reporting

The best beam identified by the W TRU (e.g., UE) may be informed to the network node (e.g., gNB); this may be called beam reporting. A random access channel (RACH) may be an uplink channel used during initial access or when a WTRU (e.g., UE) may be out of synchronization with the network and may (e.g., need to) establish synchronization. In idle mode, after the W TRU (e.g., UE) selected the beam, there may be one or more RACH interval for the WTRU (e.g., UE) with a certain time and frequency offset, which it may transmit the RACH preamble. The WTRU (e.g., UE) may transmit the physical RACH (PRACH) preamble corresponding to the SS block for which the best beam was identified. There may be a one-to-one mapping between the received SS block and the transmitted RACH preamble. This may be a way for the WTRU (e.g., UE) to report the best beam to the network node (e.g., gNB) as the network node (e.g., gNB) upon receiving RACH in a given interval can back-calculate the best beam through which a WTRU (e.g., UE) might have received the best synchronization signals.

The network may configure the WT RU (e.g., ULE) to perform certain measurements and report them on a preconfigured interval; this process may be called measurement reporting. In connected mode, in a case where (e.g., when) the WTRU (e.g., UE) may be already connected with the network node (e.g., gNB) and active data transfer may be taking place, it may report the beam through a measurement report to the network node (e.g., gNB).

### Beam Switching

Switching from one beam to another can also be called intra-cell mobility or beam-level mobility. Beam switching may be based on a trigger condition for abeam and the configured beam switching algorithm. This may be applicable in a case where (e.g., when) the WTRU (e.g., UE) may be in connected mode and can be done through L1/L2 procedures. On the other hand, handover may be used typically for inter-cell mobility and may be an L3 procedure.

### Beam and Link Failures

In this section, we describe briefly the 3GPP procedures detecting the beam failure (recovery) and radio link failure.

### Beam Failure Detection and Recovery (BFDR)

In a case where (e.g., when) a WTRU (e.g., UE) and the network node (e.g., gNB) may be communicating through narrow beams, the WTRU (e.g., UE) mobility and/or the changes in the wireless environment may lead to deterioration of the beam pair. Beam level measurements and continuous evaluation may be key procedures which help maintain and switch to the best beam pair between a WTRU (e.g., UT) and the network node (e.g., gNB). These procedures may be jointly called beam failure detection and recovery (BFDR).

In a case where (e.g., when) the quality of a beam deteriorates, PHY layer of a WTRU (e.g., IE) may generate “Beam Failure Instance (BFI)” in a case where (e.g., when) the measurements from the configured reference signals for this beam fall below a configured threshold. The MAC layer may maintain “BeamFailurelnstance Counter”. The MAC layer may increment the BFI counter and/or may reset the “Beam Failure Detection Timer” for each instance of the PHY layer reporting BFI. If BFI counter exceeds a configured value, beam failure may be detected. For beam failure detection (BFD), this should happen within the beam failure detection timer.

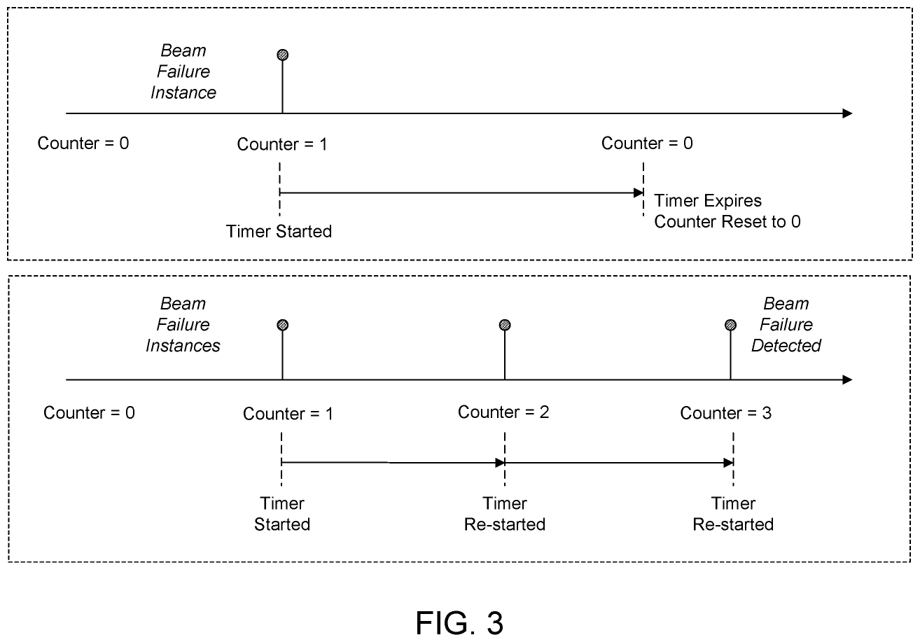

FIG. 3 shows two example situations with beam failure procedure. The upper sub-figure shows the case where (e.g., when) the MAC layer receives a BFI from the PHY layer, but the beam failure detection timer expires, and no beam failure may be generated. The lower sub-figure shows the case where the PHY Layer may be reporting BFI at a rate which may be not letting the timer expire and BFI counter reaches the BFD threshold, and the MAC layer will generate BFD.

After the detection of beam failure event, a WTRU (e.g., UE) may initiate a beam failure recovery (BFR) procedure. In a case where (e.g., once) beam failure has been detected, a WTRU (e.g., UE) may try to recover from the beam failure if the candidate recovery beams are configured. The WTRU (e.g., UE) may try to validate the configured candidates for a given serving cell according to the configured/defined measurement quality criterion and thresholds. It may prepare a BFR MAC-CE or a truncated BFR MAC-CE according to the defined conditions where the cells and recovery beams may be indicated for network knowledge.

The actual beam recovery procedure may differ whether the beam failure is detected on a special cell (SpCell) (this may be the primary cell of the master cell group. For dual connectivity operation, this could be the primary cell of the secondary cell group) or on a secondary cell (SCell). Here the 3GPP definition is adopted for SpCell and SCell as provided in TS38.331 for example. For beam recovery procedure on a SpCell, after validating the configured candidate beams, a WTRU (e.g., UE) may choose a suitable validated candidate beam for RACH transmission. Normal or truncated BFR MAC-CE may be sent as part of the RACH procedure. RACH transmission may follow the parameters configured as part of the candidate beam configuration. A successful RACH may let the network know that the WTRU (e.g., UE) has recovered through this candidate beam. For beam recovery procedure on a SCell, after having validated the candidate beams, a WTRU (e.g., UE) may transmit the BFR MAC-CE or truncated BFR MAC-CE to the network. A RACH procedure may not be initiated for beam failure recovery on a SCell. Further details on beam failure recovery procedure and MAC CE contents can be found in TS 38.321.

### Radio Link Failure (RLF)

A WTRU (e.g., UE) may perform radio link monitoring (RLM) based on the synchronization signal block (SSB) or/and the channel state information reference signals (CSI-RS), and/or the signal quality thresholds configured by the network. The PHY layer at a WTRU (e.g., UE) may make the measurements and pass them on to the MAC and the RRC layers. The MAC layer may be responsible for detecting beam failures, while the RRC layer may be responsible for detecting Radio Link Failure (RLF). The network may use RRC signaling to configure a WTRU (e.g., UE) with the RLM reference signals (RLM-RS) and the associated thresholds. RLM-RS can be SSB, or CSI-RS or a combination of the two. The network may configure the timers to be used for RLF detection/determination as part of the primary cell configuration. The PHY layer may generate an “Out-of-sync (OOS)” indication in a case where (e.g., when) the radio link quality belonging to all of the monitored RS may be worse than the configured threshold. The PHY layer may generate an “In-Sync” indication in a case where (e.g., when) the radio link quality belonging to at least one of the monitored RS is better than a configured threshold. The In-Sync and OOS indications may be passed to the RRC layer.

The criteria to declare RLF may be listed in 3GPP TS and reproduced here:
T310 based RLF: Based on the link quality measurements (using SSBs or/and CSI-RSs), if consecutive out-of-sync indications (e.g., measurement may be below the given threshold) may be received a preset number of times, N310 times, the RLF timer T310 may be started. If the channel quality recovers before the T310 timer expires, the T310 timer may be reset; otherwise, upon expiration of the T310 timer, an RLF may be declared.
T312 based RLF: The WTRU (e.g., UE) may start the T312 timer upon triggering a measurement report for which the T310 timer may be already running. The T312 timer may allow the WTRU (e.g., UE) to differentiate between an RLF caused by a handover failure or an RLF caused by coverage hole. The T312 timer may be typically shorter than the T310 timer. If the channel quality of the source network node (e.g., gNB) may be worse than a threshold, the shorter T312 timer may expire earlier and a RLF may be timely declared.
Random access procedure failure: If multiple RACH attempts to connect to a network node (e.g., gNB) fail consecutively, an RLF may be declared.
Failure in Beam Failure Recovery procedure: A failure in recovering to a suitable beam after detecting beam failure may lead to an indication of link failure.
RLF due to reaching the maximum number of re-transmissions from radio link control (RLC) layer.

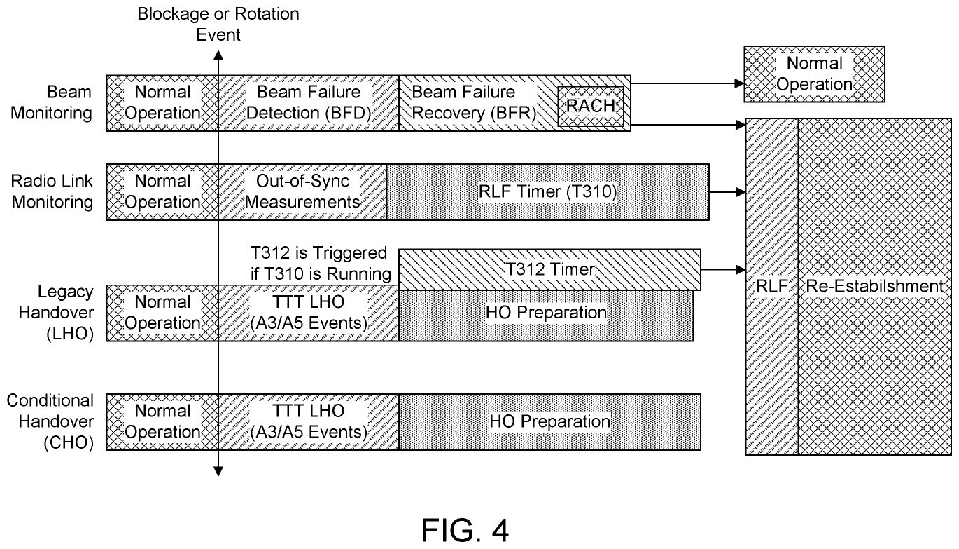

In a case where (e.g., when) the beams and links are deteriorating, the BFDR, RLM, and handover procedures may run concurrently, as illustrated in FIG. 4. Each individual procedure can lead to an RLF. In a case where (e.g., when) the WTRU (e.g., UE) is configured to use legacy handover (HO), the link outage may interrupt the measurement reporting and/or HO initiation. The HO operation may fail. The BFDR procedure may attempt to recover through BFR (e.g., in parallel). If the recovery attempts fail, an RLF may be declared by the BFDR procedure. In a case where (e.g., when) the WTRU (e.g., UE) is configured to use conditional handover (CHO), in a case where (e.g., once) the serving link starts to degrade, a WTRU (e.g., UE) may evaluate the execution condition for the conditional handover and/or may handover to the target cell if the execution condition is satisfied.

### Mobility Issues in Directional Systems

At higher frequencies such as the anticipated sub-THz and THz frequency range for 6G systems, due to high attenuation and path loss, larger antenna arrays (number of antenna elements ranging from tens to hundreds) may be used to form high gain highly directional narrow beams which may ensure desirable coverage level at such high frequencies. As we move higher in the frequencies, the beams may become further narrower. The highly directional links resulting from narrow beams at both WTRU (e.g., UE) and network node (e.g., gNB) may be much more sensitive to the dynamic changes in the environment compared to the conventional links. Another important aspect of such high frequency systems may be the network densification with shorter coverage areas for any (e.g., each) transmission reception point (TRP).

For these highly densified systems with highly directional narrow beams, mobility events (translational, rotational) or blockage events may be expected to be much more frequent. Beam quality may be likely to degrade much quicker and frequently as a result of the beam being highly directional. Consequently, the time budget to perform measurements, report measurement results (for example in the case of network control mobility), process the measurements, make mobility decision and execute the mobility decision may be extremely tight, making the traditional radio measurement-based approach to mobility/beam management impractical. This situation may get further aggravated in the face of future applications requiring even more stringent quality of service requirements. These mobility events may be the result of translational motion, rotational motion or the change in the wireless medium. The WTRU (e.g., UE) rotations may come from rotational movements of handset/wearable devices such as smartphone, game controllers, and VR/XR headsets, etc. These movements may originate from hand gestures, head movements etc. The WTRU (e.g., UE) rotations may lead to channel variations between the serving network node (e.g., gNB) and the WTRU (e.g., UE) which may cause beam misalignment or even the link/connection failures. Other types of dynamic changes may originate from translational mobility. Still another type of change can come in a case where (e.g., when) a serving link/beam may get blocked by a moving object or a mobile blocker in the surrounding environment. To make matter worse, these changes may happen in any combination requiring degradation/failure of multiple beams/links. Future applications with stringent QoS requirements may require faster recovery from such situations no matter the cause, otherwise there may be risk of not meeting the QoS requirements and a compromised user experience. In such highly directional systems, the robustness and reliability of the existing mobility/beam management procedures, which heavily rely on radio signal measurements may be challenged. New mobility/beam management methods that rely less on radio signal measurements may be used (e.g., required). It should be understood here in that the term mobility procedure or method may be used in reference to both the traditional mobility procedures such as handover, as well as beam management procedures.

The mobility may result in sudden beam failure with the serving/source network node (e.g., gNB), and the WTRU (e.g., UE) may not have discovered the neighboring beams available in the vicinity from the same serving TRP, from neighboring TRP, from serving cell, or from neighboring cell, either as candidate beams to be measurements and reported to the network, or as candidate beams to be switched to as part of the beam failure recovery procedure. The reason for non-detection could be insufficient time for the network to configure the measurements and gaps, and for the WTRU (e.g., UE) to make these measurements if configured. The missing configurations to recover from the beam failure events results in loss of connections and longer recovery delay despite beams/cells available in the vicinity from same network node (e.g., gNB) or from neighboring gNBs. The new methods may (e.g., need to) be designed to avoid such problems of missing suitable configurations at WTRUs (e.g., UEs).

Another (e.g., major) issue for operation in the dense networks with large number of narrow beams may be the power consumption, in general for transmission/reception purpose and in particular for making measurements on all such narrow beams from different TRPs. In such environments, the devices may (e.g., need to) make measurements on neighboring beams/cells, and due to directionality and pathloss, the measurements may (e.g., need to) be made through suitable receive beams. Thus, a device may consume a lot of power in terms of reception and computation for making measurements over the neighboring beams. In addition to the huge power disadvantage, the beam steering for measurement purpose further adds “outage” from the perspective of the serving beam/link. Lean procedures may (e.g., need to) be defined to reduce the WTRU (e.g., UE) power consumption for beam/cell measurements over the neighboring beams/cells.

The primary focus of this disclosure is to propose embodiments for beam failure detection, report and recovery that depart from exclusively using radio measurements, to using other non-radio-based measurement information such as network deployment data, positioning, future device movements data, and other sensing information.

### Approach to Minimize Mobility Interruptions

### Overview of the Embodiments

Minimization of mobility interruption has been a key subject in wireless communication systems. Evolution of wireless systems with the new applications requiring low-latency, high-reliability and high-availability has resulted in greater focus and activity to this subject. To that end, 3GPP has defined and standardized a number of mechanisms where mobility interruptions may be minimized through faster switching of beams, cells and network nodes.

This disclosure proposes several embodiments to achieve Proactive mobility handling for beam based systems. According to embodiments, proposed approaches may be the combining of (i) the knowledge of network deployment of its nodes/cells/beams and (ii) the ability of a WTRU (e.g., UE) to track its movements and/or determine updated geographic location/position and/or orientation.

The WTRU (e.g., UE) ability to detect its geographic coordinates, location and orientation in a highly timely manner can be used to select (e.g., deterministically) the suitable node/cell/beam to which this WTRU (e.g., UE) should be connected to. The mobility decisions may be moved to the WTRU (e.g., UE) side. To make such decisions with respect to the latest WTRU (e.g., UE) position, orientation and potentially the change in the network environment, the network may share a suitable finite piece of its deployment/coverage ensemble to the WTRUs (e.g., UEs). The details on the ensemble contents, configuration, maintenance, signaling mechanisms, and WTRU (e.g., UE) post-processing over such ensembles may be provided in the following section.

After acquiring the network shared deployment or coverage ensemble, a WTRU (e.g., UE) can use this information in combination with any of: its latest movements, positions, orientation, and any change in the network environment to minimize mobility interruptions and outages. This disclosure proposes a framework of making measurements on several newly defined non-radio measurement quantities with special interest on position, location, and orientation detection. This allows a WTRU (e.g., UE) to combine legacy radio-measurement quantities with the newly proposed non-radio measurement quantities to design special suitable events and triggers to handle mobility procedures such as beam failure recovery. The measurement framework, measurement quantities and combined events on radio and non-radio measurement quantities may be described hereafter.

The proposed embodiments in this disclosure provide system level design for proactive beam failure recovery, building upon the frameworks of (i) deployment/coverage zones which may be indicated by the network to a WTRU (e.g., UE) through suitable signaling, and (ii) non-radio measurements and events combined with radio measurements estimated and evaluated at the WTRU (e.g., UE), and performing the proposed beam recovery procedure.

### Deployment and Coverage Zones

The cellular networks may be planned networks with operators deploying the network nodes at suitable locations to provide sufficient coverage to their subscribers. The network operator may have very precise knowledge of its deployment of cells, and the beams within those cells in terms of coverage zone attributes such as the locations (reference location) of cells or TRPs, potential spatial directions of transmission defined for example by azimuth, elevation angles and location coordinates of the TRPs, beam width information such as 3-dimensional (3D) beam width information, for example in horizontal and vertical directions, transmission range information, coverage shape information including for example location coordinates of points that constitute the coverage border of a beam, cell or TRP.

### Deployment Ensemble

The deployment ensemble may comprise any of: information about the location of TRPs and coverage/orientation of beams. According to embodiments, the location of TRPs can be represented in terms of 2D coordinates, with an example of 2D coordinates the latitude and longitude coordinates. The location can be represented in 3D coordinates with the addition of altitude or height to 2D coordinates. Both 2D or 3D representations can be in global or local coordinate systems.

The beams from a given TRP can be represented using azimuthal and elevation angles. Suitable references can be used like cardinal directions and zenith, or reference directions can be provided as part of the configuration. These angles can be provided with suitable refinement or quantization to capture meaningfully the mobility procedures and signal strengths within or out of the coverage for a given beam. In addition to the angles, the beam widths in these directions can be additionally provided explicitly for the beams. Having the knowledge of the TRP location parameters and the beam angles (plus widths), a WTRU (e.g., UE) can prepare a local ensemble where it can see the coverage of different beams from different TRPs. Additional attributes, like range/power can be added to cell/beam to refine further the deployment ensemble.

### Coverage Ensemble

The coverage ensemble may provide the indication of geographic coverage from different TRPs for different beams. Through suitable representations, it may provide the coverage boundary of different TRPs and different beams. The coverage ensemble may incorporate any of: the nature of the terrain, topographic aspects, buildings and other geographic parameters on the deployment ensemble to prepare suitable zones and boundaries associated to the coverage of different beams from different TRPs.

The representation of the coverage ensemble can be in the form of suitable geometric shapes. To indicate the shapes delimiting the cells/beam level coverage, different reference shapes can be defined. The reference shapes can be in the form of circles, ovals, ellipse, ellipsoids with suitable parameterization. The coverage ensemble may be indicated using these shapes with suitable attributes. These attributes may provide links to the cell/beam identities to which a given shape/area may be associated.

### Configuration

This disclosure will use the term deployment ensemble and coverage ensemble synonymously. When distinction is required, it will be mentioned explicitly.

A coverage ensemble may be associated with an area denoted here coverage ensemble area. A coverage ensemble area may correspond to one or more cells, a RAN Notification Area (RNA), a tracking area (TA), a PLMN, etc.

The coverage ensemble may be defined at different granularities. The granularity of the coverage ensemble may be part of the coverage ensemble configuration. In one embodiment, the coverage ensemble may be defined at cell level and the information of geographic coverage from different gNBs/TRPs may be indicated to WTRUs (e.g., UEs) with suitable signaling. The cell level coverage can be useful for different hand-over and cell change procedures.

The coverage ensemble granularity may be reflected in the form of coverage zones. For cell level procedures, the coverage ensemble zones can have the cell level granularity. For beam level procedures where for example a WTRU (e.g., UE) may (e.g., need to) track, maintain or switch beams, the coverage ensemble granularity may be defined at beam level, and the zones in such a coverage ensemble be attributed to different beams.

The zones can be attributed to given beams from given TRPs. A further refined granularity can be achieved by defining and associating zones to different directions from any (e.g., each) network node (e.g., gNB) or TRP. The zones in the coverage ensemble can be indicative of the geographic area which corresponds to a given set of reference signals. For beam level zones, in one embodiment, any (e.g., each) zone can indicate the coverage area for an SSB beam. In another beam level zone design, any (e.g., each) zone can indicate the coverage area for an SSB beam or a CSI-RS beam where SSB/CSI-RS beam may be the coverage for the corresponding SSB/CSI-RS signals.

Any (e.g., each) zone can be identified with an identity, which can be provided as part of the configuration. In another embodiment, any (e.g., each) zone identity can be a deterministic combination of identities of cells, TRP, SSB/CSI-RS beam that it may be attributed to. The formulae to compute zone identity can be known to the network and the device a-priori, and they can use additional modulating parameters such as lengths, widths, number of SSB beams etc. which can be part of the system information or the configuration.

A different granularity for the zones can be at gNB, TRP or cell level. For cell level zones, the zone may indicate the area where this cell has sufficient coverage. The cell level zone can group (e.g., all) the SSB/CSI-RS zones associated with a given cell and it may represent the area where any of the SSB/CSI-RS signals for this cell can be received with a known/configured quality. The zone representation can be extended to larger granularities for RNA, TA or PLMN based coverage zones. The cell level zone identity can be the cell identity or a deterministic modification of the cell identity by combining it with some other parameters. The same design can be used for zones to represent the coverage for RNA, TA, PLMN etc.

In an alternative embodiment, the zones may be defined for any (e.g., each) location using its longitude and latitude values. The zone length information can be provided as part of the configuration. The formulae to compute the zones can be pre-defined or could be signaled as part of the configuration from a pre-defined set. This embodiment may facilitate the zone identities computation, for example, as standardized in the 3GPP NR Sidelink work in Release-16. For this embodiment, the longitude and latitude values may be the geodesic distances from the geographical coordinates (0,0), for example, as in used in the NR sidelink framework. Suitable parameters can be provided as part of the configuration to choose the zone modularity along the longitude and latitude directions. (E.g., only) one single parameter can be used to choose the same modularity along longitude and latitude directions. This parameter can be a fixed value to ease the configuration. In this embodiment, all the devices can compute their zones and the zones for any location against the longitude and latitude coordinates of that location.

### Network Deployment Configuration

The deployment ensemble may comprise any of: information about the location of TRPs and coverage/orientation of beams. In one example, the location of TRPs can be represented in terms of 2D coordinates, with an example of 2D coordinates the latitude and longitude coordinates. The location can be represented in 3D coordinates with the addition of altitude or height to 2D coordinates. Both 2D or 3D representations can be in global or local coordinate systems. If the zone's configuration follows the sidelink design, the TRP locations can be provided against the zones instead of the longitude and latitude coordinates.

The beams from a given TRP can be represented using azimuthal and elevation angles. Suitable references can be used like cardinal directions and zenith, or reference directions can be provided as part of the configuration. These angles can be provided with suitable refinement or quantization to capture meaningfully the mobility procedures and signal strengths within or out of the coverage for a given beam. In addition to the angles, the beam widths in these directions can be additionally provided explicitly for the beams.

### Network Coverage Configuration

The network can directly provide the configuration in the form of rich shapes which capture all the specific aspects of the local terrain, shadowing from buildings and other objects. The advantage of this scheme may be that the network not only precisely knows the deployment of its cells/TRPs and beams but in addition, it may have access to topographical data using a navigation system, cameras, and the ongoing measurements on cells/beams from the devices which let it know very precise coverage ensemble. One additional advantage may be the use of all historic data in the form of network measurements, cells/beam transitions that can be used to update and refine such detailed coverage ensembles. This approach may have a large signaling overhead. The amount of information that may (e.g., needs to) be exchanged can be huge as the precise coverage for even a single beam may use (e.g., require) a set of objects and their attributes communicated to a WTRU (e.g., UE). The large signaling overhead may use (e.g., require) several message exchanges at RRC level leading to increased configuration latency as well.

If the zone's configuration follows the sidelink design, the network may provide different cells and beams coverage indication which provides the association of these cells and beams to zones.

### Hybrid Configuration

The ensemble configuration can be a hybrid of the two earlier approaches where some part may be indicated in the form of network deployment based configuration and some part may be indicated using the coverage ensemble based configuration.

### Initial Configuration of Deployment/Coverage Ensemble

In one embodiment, the initial configuration for the coverage ensemble can be communicated to a WTRU (e.g., UE) in the form of dedicated RRC signaling. A WTRU (e.g., UE) in RRC active state with mobility can be provided the initial coverage ensemble configuration. From the WTRU (e.g., UE) perspective, the signaling may be dedicated but the network can provide the same information to a set of WTRUs (e.g., UEs). These WTRUs (e.g., UEs) can be in the vicinity of each other and the same coverage ensemble may be relevant for them.

In another approach, the network (e.g., the base station) may broadcast coverage ensemble information. A New coverage ensemble system information block (SIB) may be specified. It may be understood that in this case, the coverage ensemble information broadcasted by a cell or a TRP may be configured to reflect the local deployment environment of the cell or TRP broadcasting the coverage ensemble.

For many relevant cases, the initial configuration can provide a coarse coverage ensemble which may (e.g., need to) be refined to suitable granularities and coverage extension to be fully useful. The coverage ensemble can be refined suitably through dedicated signaling. The refinement can be network initiated in a case where (e.g., when) it may be configuring certain applications/flows with QoS constraints necessitating proactive mobility. In a compatible embodiment, a WTRU (e.g., UE) can request the refinement of its coverage ensemble.

### WTRU (e.g., UE) Processing to Achieve Effective Coverage Ensemble

The network deployment ensemble may be shared with WTRUs (e.g., UEs) following the configuration embodiments, for example, as proposed earlier, by adding additional attributes to the cell configuration or by introducing new configurations having these geographic attributes and providing the links of these TRP/beam level configurations to the legacy cell configurations. To use in mobility events and effective selection of beams, cells, TRPs, a WTRU (e.g., UE) may (e.g., need to) have a detailed effective coverage ensemble that we may call on-the-ground coverage ensemble. There may be still a question of how to make the deployment ensemble rich enough so that it captures all the topographical and shadowing aspects. This coverage ensemble should take into account not only the TRP locations and beam attributes, but it should incorporate the physical nature of the environment around including the specifics of the terrain, the buildings with all their physical attributes which may shadow, block or reflect the beams. Embodiments are proposed below which enable a WTRU (e.g., UE) acquiring/fabricating the on-the-ground coverage ensemble.

### WTRU (e.g., UE) Processing Over Network Provided Coverage Ensemble

In one embodiment, the network provided deployment configuration itself can be made very rich and refined and provided in the form of rich shapes which may capture all the specific aspects of the local terrain, shadowing from buildings and other objects. To indicate the shapes delimiting the cells/beam level coverage, different reference shapes can be defined. The reference shapes can be in the form of circles, ovals, ellipse, ellipsoids with suitable parameterization. The network may then indicate these shapes with suitable attributes and providing their links to the cell/beam identity. An advantage of this scheme is that the network knows precisely the deployment of its cells/TRPs and beams. It may have access to topographical data using a navigation system, cameras, and the ongoing measurements on cells/beams from the devices which let it know very precise coverage ensemble. One additional advantage may be the use of all historic data in the form of network measurements, cells/beam transitions that can be used to update and refine such detailed coverage ensembles. This approach may have a large signaling overhead. The amount of information that may (e.g., needs to) be exchanged can be huge as the precise coverage for even a single beam may use (e.g., require) a set of objects and their attributes communicated to a WTRU (e.g., UE). The large signaling overhead may use (e.g., require) a number of message exchanges at RRC level leading to increased configuration latency as well.

### WTRU (e.g., UE) Processing Over Network Provided Deployment Ensemble

In this design approach, the network may provide to WTRUs (e.g., UEs) a snapshot of its nodes' deployment and limited information about the beams it may transmit. Thus, this approach may be mainly used in a case where (e.g., when) the network may be providing its deployment configuration. In this embodiment, the network may provide the information about the TRP locations, beam angles and beam specific parameters without modulating the coverage with the features of the local terrain. Due to little information compared to the approach where the network may provide the detailed coverage ensemble, the signaling overhead and latency performance of this approach may be much better than the former.

In this embodiment, the devices are supposed to get the deployment features/parameters for TRPs/beams and using the local knowledge through other technologies (local stored topography, positioning systems, cameras) may prepare a refined coverage ensemble which may add the topographical aspects to the deployment configuration. In this embodiment, after the local processing and fabrication, the WTRUs (e.g., UEs) get the effective ensemble which may delimit different coverage zones associated to different beams and cells. This refined coverage ensemble may be used in the beam and cell level mobility procedures at this WTRU (e.g., UE). This local physical coverage ensemble can be refined with the mobility or additional information obtained from other sensors. As the devices prepare this effective ensemble using the network provided deployment parameters combined with the information from local sensors, this may use (e.g., requires) availability of local sensors, additional storage and compute capability to prepare effective ensembles by combing network deployment with the information from local sensors.

Hybrid embodiments may be standardized to get the refined coverage ensemble at the devices. If there are devices which may not be equipped with necessary local sensors, or they may not have necessary compute power to process and fabricate an ensemble themselves, the network can send the refined ensemble to such devices. Contrary to this, the devices having necessary local sensors and compute/storage power may receive (e.g., only) limited deployment features from the network and prepare the effective ensemble locally. The hybrid embodiments may be used depending upon WTRU (e.g., UE) power consumption requirements, battery quality, remaining battery or as a function of active applications and their attributes.

### Maintenance of Deployment/Coverage Ensemble

Upon detection of change in coverage ensemble area, the WTRU (e.g., UE) may re-acquire a coverage ensemble for its current location. The re-acquisition can be in the form of dedicated RRC signaling. In another embodiment, it could be through re-acquiring the coverage ensemble SIB. The WTRU (e.g., UE) detection of change in coverage ensemble area may comprise any of the followings:
A change in serving cell or (re)selection to a cell that may not belong to the current coverage ensemble area.
A (re)selection to an RNA that may not belong or may not correspond to the current coverage ensemble area.
Execution of an RNA update procedure, or transmission of an RNA update message to the network (base station)
A (re)selection to a TA that may not belong, or ensemble that may not correspond to the current coverage ensemble area.
Execution of a TA update procedure, or transmission of a TA update message to the network (core network).
A (re)selection to a PLMN that may not belong, or ensemble that may not correspond to the current coverage ensemble area.

### Release of Deployment/Coverage Ensemble Configuration

The WTRU (e.g., UE) may discard the coverage ensemble configuration information if it gets outdated. The outdated indication can be derived if the WTRU (e.g., UE) changes its coverage area and may be not able to acquire the updated coverage ensemble. In another embodiment, the configuration can comprise (e.g., explicit) timers which may result in WTRU (e.g., UE) releasing the configuration if expired. These timers may be refreshed if the WTRU (e.g., UE) is staying in the area associated with its current coverage ensemble. The coverage ensemble area can be defined in terms of RNA, TA, PLMN or another suitable criterion.

The network can send an (e.g., explicit) indication to the WTRU (e.g., UE) to release its coverage ensemble configuration.

The WTRU (e.g., UE) may release the coverage ensemble configuration if it goes out of RRC active state.

### Network Indication of Deployment/Coverage Ensemble

This disclosure proposes the following compatible embodiments through which deployment ensembles may be provided to a WTRU (e.g., UE) and how to relate the cells/beam configurations and mobility configurations with the deployment configuration.

### Ensemble Indication as Part of Cell Beam Configuration

In a first embodiment, the deployment ensemble can be part of the cell configuration. This cell configuration can be part of the conditional (re-)configuration associated with candidate cells which can be part of a conditional handover or conditional PSCell change/addition procedure. The deployment ensemble can be associated to any of the serving cell configuration and can be used for any of the beam management procedures, namely beam switching, beam failure recovery etc. New attributes may be added to the cell configuration which may define the TRPs where this cell may be being transmitted, the locations of these TRPs in suitable global or local coordinate systems, and the beam coverage attributes for the beams being transmitted through these TRPs. The configuration can provide the information on SSB beams or CSI-RS beams. The attributes for beams can be in the form of azimuthal and elevation angle with suitable reference directions. The reference directions can be taken from cardinal directions or can be indicated as part of the configuration itself. The range for the beams can be indicated as per beam attribute or a single value which may indicate the unobstructed range in view of the transmit power. The beam attributes may define the beam width in horizontal and vertical directions. A simpler deployment can specify one single beam width attribute for horizontal and one for vertical directions which may be assumed to be the same for (e.g., all) the configured beams. For the deployments with varying beam width sizes, the network can provide one value for a TRP, and delta values may be provided for any (e.g., each) beam. An alternative embodiment may provide beam width as part of the beam configuration without any TRP or cell level indication. In yet another embodiment, the coverage for any (e.g., each) beam may be specified as an ellipsoid with suitable parametrization.

### Ensemble Indication as Independent Dedicated Configuration

In this embodiment, the ensemble may be provided as an individual configuration to WTRUs (e.g., UEs). In this embodiment, the coverage ensemble configuration may not be part of the cell configuration or the conditional (re-)configuration. The coverage ensemble may depend upon the geographic deployment and coverage but its configuration and signaling may be provided by the network independent of the cell configuration or other conditional (re-) configurations.

The coverage ensemble configuration can be in the form of network nodes deployment and beam attributes, or it can be in the form of on the ground detailed coverage incorporating the topographic and/or terrain specific features. The coverage/deployment ensemble configuration can provide the linkage of indicated TRP locations and beam attributes to the cell identities and cell configurations.

### Ensemble Indication as Broadcast Signaling

In this embodiment, the deployment/coverage ensemble indication may be transmitted by the network in the form of broadcast signaling. This information can be broadcast by the network and the relevant devices can be pre-informed or may have prior knowledge of how to get and decode this information. The control information to locate the ensemble related broadcast information can be broadcast, e.g., through a special paging or a special downlink control information informing all the devices about the broadcast based ensemble information.

In a compatible embodiment, the ensemble indication can be treated as part of the system information. New SIB can be designed which carry and convey deployment/coverage ensemble indication. The network can use periodic transmission of ensemble SIB to keep the WTRUs (e.g., UEs) aware of the ensemble information. The WTRUs (e.g., UEs) which may be starting the relevant services where outage may (e.g., needs to) be minimized can send (e.g., explicit) request to the network requesting the transmission of the ensemble SIB.

### Measurements

A key part of the embodiments proposed in this disclosure may be the radio measurements, non-radio measurements and their combinations which may be used in an intelligent manner to trigger certain events combined with the provisioning of additional information from the network.

The devices may be equipped with interfaces from non-3GPP RATs, local sensors, or may be getting the environmental information and quantities from certain accumulation points. Usage of these quantities and their integration with the measurements over 3GPP standardized RATs may use (e.g., need) a harmonized framework where WTRUs (e.g., UEs) can use the data from non-3GPP RATs alone or in combination with the data/measurements over 3GPP RATs. The following sub-sections aim to provide a framework through which measurements or data quantities from non-3GPP RATs/sensors can be used for beam change and cell change procedures.

### Configuration

From 3GPP perspective, the measurement procedures and the framework may be based upon measurement identities. A measurement identity may link a measurement object with a reporting configuration. A measurement object may constitute an object over which WTRU (e.g., UE) may perform measurements, and may indicate a combination of time, frequency, bandwidth, sub-carrier spacing parameters relevant for the reference signal over which WTRU (e.g., UE) may perform measurements. A reporting configuration may provide the reporting criterion, the nature of the reporting whether periodic, event trigger or cell global identity reporting. For event triggered reporting, the reporting configuration may provide the triggering event and the suitable parameters relevant for that event.

Measurement objects may provide a pointer to the quantity configuration. A quantity configuration may provide the measurement filtering configuration which may be applied to measurements prior to event evaluation and reporting.

In the current 3GPP measurements framework, a measurement identity may be (e.g., is always) linking a measurement object and a reporting configuration. The current measurement objects may belong to the same RAT through which measurements may be being configured or inter-RAT measurements defined over other 3GPP technologies. For non-radio-measurements from non-3GPP RATs, from local sensors or from other sources, there can be, for example, embodiments outlined in the following subsections.

Measurement Identities with a Measurement Object with Limited Attributes:

One embodiment can be to extend the 3GPP measurement framework such that a measurement identity can provide a link of reporting configuration to a dummy measurement object which may have very limited attributes. For non-radio-measurements, the reporting configuration can provide the information about the quantities with the events that may (e.g., need to) be evaluated, reported and used for decision making to perform the beam switching, cell switching, or broadly used in (e.g., all) conditional reconfiguration. The dummy measurement object can provide some parameters which may be used to choose some aspects of the non-measurement data. They may provide a selection of parameters to be used in a case where (e.g., when) a non-3GPP interface or local sensor may be known to provide information in multiple forms and formats. These measurement objects may also indicate special filtering to be applied to these non-radio-measurement quantities through updated quantity configuration.

Measurement Identities without a Measurement Object:

According to an embodiment to extend the 3GPP measurement framework spanning the data coming from non-3GPP RATs, local sensors and other sources can be to define the measurement identities which may (e.g., only) provide a pointer to the reporting configuration without any measurement object. The reporting configuration can be extended with the new events and relevant parameters which may provide the information to handle the non-radio measurements in a suitable manner.

### Post-Processing and Filtering for Measurements

For some of the non-radio measurements, measurement objects may provide the selection of the suitable parameters which may be to be kept and used as part of non-radio measurement framework. The quantity configuration may provide additional post-processing or filtering coefficients which can be applied to the non-radio measurements. The objective of this filtering or post-processing may be to do the additional processing to make these measurement quantities suitable for use in 3GPP procedures such as used for mobility and conditional reconfiguration etc.

### Measurement Reporting, Triggers and Conditional (Re-)Configuration

The reporting for non-radio measurements can work very much in the same manner as for radio measurements. The same may be true for the role of non-radio measurements to trigger the events and the use of these measurements and indicated events for the mobility procedures and conditional reconfigurations.

For the embodiments proposed in this disclosure, one of the (e.g., fundamental) themes may be the network sharing the suitable piece of deployment ensemble and the WTRUs (e.g., UEs) able to make intelligent decisions, trigger change of beams and cells, use of local radio and non-radio measurements in the mobility procedures like beam recovery, conditional handover, conditional PSCell addition/change etc.

The reporting configuration can be expanded to include the new non-meas-data based events where WTRUs (e.g., UEs) may use the data from local sensors. These events may use the deployment attributes of cells and beams, both serving (from primary cell group or secondary cell group) and neighboring cells/beams obtained from the deployment configuration. The events may be created based upon the sensor non-meas-data. These events can be combined with the measurement data events, for example, to validate the suitability of cells/beams for certain signal strength etc. In another compatible approach, composite events may be designed where conditions may be specified for both non-meas-data-quantities (like location/angle) and measurement quantities (like SSB/CSI-RS RSRP/RSRQ/SINR) and these composite events may be triggered in a case where (e.g., when) the suitable conditions from both groups may be specified. The triggering of these composite events may lead to the execution of the conditional (re-)configuration.

Current conditional reconfiguration may have a plurality of (e.g., at most 2) measurement identities. With the non-meas-data based events used (e.g., needed) in combination with meas-data based events, the number of events may (e.g., need to) be increased. In a compatible embodiment, joint meas and non-meas events can be created.

The WTRUs (e.g., UEs) may be evaluating events configured over a suitable combination of radio and non-radio measurements. The details on how these events may be used in specific procedures are explained in the relevant embodiments. Some of the exemplary events on non-radio measurements are described in the following sub-sections.

Event V1 [Velocity Becoming Larger than a Certain Threshold]

### The WTRU (e.g., UE) Shall:

consider the entering condition for this event to be satisfied in a case where (e.g., when) condition V1-1, as specified below, may be fulfilled;
consider the leaving condition for this event to be satisfied in a case where (e.g., when) condition V1-2 as specified below, may be fulfilled;

### Inequality V1-1 (Entering Condition 1):

$$Mv - Hys > Thresh 1.$$

### Inequality V1-2 (Leaving Condition 1):

$$Mv - Hys > Thresh 2.$$

The variables in the formula may be defined as follows:
Mv may be the WTRU (e.g., UE) velocity estimated by WTRU (e.g., UE) through its local sensors not taking into account any offsets.
Hys may be the hysteresis parameter for this event (i.e., hysteresis as defined within configuration for this event).
Thresh1 may be the threshold for this event defined as a reference velocity within configuration for this event and used as velocity threshold to enter this event.
Thresh2 may be the threshold for this event defined as a reference velocity within configuration for this event and used as velocity threshold to exit this event.
Mv may be expressed in Km/hour.
Hys may be expressed in the same unit as Mv.
Thresh1 and Thresh1 may be expressed in the same unit as Mv.

The definition of Event V1 may also apply to CondEvent V1.

Event R1 [Device Rotation Occurring for an Amount Larger than a Certain Threshold]

### The WTRU (e.g., UE) Shall:

consider the entering condition for this event to be satisfied in a case where (e.g., when) condition R1-1, as specified below, may be fulfilled;
consider the leaving condition for this event to be satisfied in a case where (e.g., when) condition R1-2, as specified below, may be fulfilled;

### Inequality R1-1 (Entering Condition 1):

$$Mr - Hys > Thresh 1.$$

Inequality R1-2 (Leaving condition 1):

$$Mr + Hys < Thresh 2.$$

The variables in the formula may be defined as follows:
Mr may be the WTRU (e.g., UE) rotation estimated by WTRU (e.g., UE) through its local sensors not taking into account any offsets, where the rotation estimation may be over a duration not exceeding a duration Td configured as part of the configuration.
Hys may be the hysteresis parameter for this event (i.e., hysteresis as defined within configuration for this event).
Thresh1 may be the threshold for this event defined as an amount of reference rotation within configuration for this event and used as rotation threshold to enter this event.
Thresh2 may be the threshold for this event defined as an amount of reference rotation within configuration for this event and used as rotation threshold to exit this event.
Mr may be expressed in degrees. In a compatible embodiment, Mr may be expressed in radians. In a flexible approach, the unit for Mr may be configured as part of the configuration.
Hys may be expressed in the same unit as Mr.
Thresh1 and Thresh2 may be expressed in the same unit as Mr.

The definition of Event R1 may also apply to CondEvent R1.

Event 01 [Device Orientation Changing from Serving Orientation Larger than a Threshold]

The WTRU (e.g., UE) shall:
consider the entering condition for this event to be satisfied in a case where (e.g., when) condition 01-1, as specified below, may be fulfilled;
consider the leaving condition for this event to be satisfied in a case where (e.g., when) condition 01-2, as specified below, may be fulfilled;

### Inequality 01-1 (Entering Condition 1):

$$Mo - Hys > Thresh 1.$$

### Inequality 01-2 (Leaving Condition 1):

$$Mo + Hys < Thresh 2.$$

The variables in the formula may be defined as follows:
Mr may be the WTRU (e.g., UE) rotation estimated by WTRU (e.g., UE) through its local sensors not taking into account any offsets, where the rotation estimation may be over a duration not exceeding a duration Td configured as part of the configuration.
Hys may be the hysteresis parameter for this event (i.e., hysteresis as defined within configuration for this event).
Thresh1 may be the threshold for this event defined as an amount of reference rotation within configuration for this event and used as rotation threshold to enter this event.
Thresh2 may be the threshold for this event defined as an amount of reference rotation within configuration for this event and used as rotation threshold to exit this event.
Mr may be expressed in degrees. In a compatible embodiment, Mr may be expressed in radians. In a flexible approach, the unit for Mr may be configured as part of the configuration.
Hys may be expressed in the same unit as Mr.
Thresh1 and Thresh2 may be expressed in the same unit as Mr.

The definition of Event R1 may also apply to CondEvent R1.

Event OD1 [Device Orientation and Distance Matching the Location of a Given TRP within Certain Thresholds]

### The WTRU (e.g., UE) Shall:

consider the entering condition for this event to be satisfied in a case where (e.g., when) both condition OD1-1 and condition OD1-2, as specified below, may be fulfilled;
consider the leaving condition for this event to be satisfied in a case where (e.g., when) condition OD1-3 or condition OD1-4, as specified below, may be fulfilled; Inequality OD1-1 (Entering condition 1) [Device has absolute orientation matching the target cell beam]:

$$abs ( Ou - Thresh 1 ) < Hys 1.$$

Inequality OD1-2 (Entering Condition 2) [Device is within a Suitable Distance from the Target TRP]:

$$Ml + Hys 2 < Thresh 2.$$

### Inequality OD1-3 (Leaving Condition 1):

$$abs ( Ou - Thresh 1 ) > Hys 1.$$

### Inequality OD1-4 (Leaving Condition 2):

$$Ml - Hys 2 > Thresh 2.$$

The variables in the formula may be defined as follows:
Ml may be the WTRU (e.g., UE) location, represented by the distance between WTRU (e.g., UE) and a reference location parameter for this event (i.e., reference location of candidate TRP for this event), not taking into account any offsets.
Ou may be the WTRU (e.g., UE) absolute orientation estimated by WTRU (e.g., UE) through its local sensors not taking into account any offsets.
Hys1 may be the hysteresis parameter for orientation condition used for this event.
Thresh1 may be the threshold for this event defined as an amount of reference orientation within configuration for this event and used as rotation threshold to enter this event.
Thresh2 may be the threshold for this event defined as a distance from a reference location configured in configuration for this event.
Ou may be expressed in degrees with respect to a configured measurement reference. In a compatible embodiment, Ou may be expressed in radians. In a flexible approach, the unit for Ou may be configured as part of the configuration.
Hys1 may be expressed in the same unit as Ou.
Thresh1 may be expressed in the same unit as Ou.
Ml may be expressed in meters.
Hys2 may be expressed in the same unit as Ml.
Thresh2 may be expressed in the same unit as Ml.

The definition of Event OD1 may also apply to CondEvent OD1.

### Event OD2 [Device Orientation and Distance Matching Better the Location of a Given TRP Than the Serving TRP According to the Configured Thresholds]

### The WTRU (e.g., UE) Shall:

consider the entering condition for this event to be satisfied in a case where (e.g., when) both condition OD2-1 and condition OD2-2, as specified below, may be fulfilled;
consider the leaving condition for this event to be satisfied in a case where (e.g., when) condition OD2-3 or condition OD2-4, as specified below, may be fulfilled; Inequality OD2-1 (Entering condition 1) [Device has absolute orientation aligning better the target cell TRP than the serving cell orientation]:

$$abs ( Ou - On ) - Hys 1 < abs ( Ou - Op ) .$$

Inequality OD2-2 (Entering Condition 2) [Device May be within a Suitable Distance from the Target TRP]:

$$Dn - Hys 2 < Dp .$$

### Inequality OD2-3 (Leaving Condition 1):

$$abs ( Ou - On ) + Hys 1 > abs ( Ou - Op ) .$$

### Inequality OD2-4 (Leaving Condition 2):

$$Dn + Hys 2 > Dp .$$

The variables in the formula may be defined as follows:
Ou may be the WTRU (e.g., UE) reference orientation in absolute units estimated by WTRU (e.g., UE) through its local sensors not taking into account any offsets.
Op may be the orientation of the serving TRP in absolute units from the WTRU (e.g., UE) as estimated by WTRU (e.g., UE) using the location of the serving TRP received in configuration.
On may be the orientation of the neighbour TRP in absolute units from the WTRU (e.g., UE) as estimated by WTRU (e.g., UE) using the location of the neighbour TRP received in configuration.
Hys1 may be the hysteresis parameter for orientation condition used for this event.
Dp may be the distance between WTRU (e.g., UE) location and the location of the serving TRP where the location of the serving TRP may be part of the configuration.
Dn may be the distance between WTRU (e.g., UE) location and the location of the neighbour TRP where the location of the neighbour TRP may be part of the configuration.
Hys2 may be the hysteresis parameter for distance condition used for this event.
Ou may be expressed in degrees with respect to a configured measurement reference. In a compatible embodiment, Ou may be expressed in radians. In a flexible approach, the unit for Ou may be configured as part of the configuration.
Op, On and Hys1 may be expressed in the same unit as Ou.
Dn may be expressed in meters.
Dp and Hys2 may be expressed in the same unit as Dn.

The definition of Event OD2 may also apply to CondEvent OD2.

Event CM1 [Device crossing out the boundary of a specific zone in the coverage Ensemble]

### The WTRU (e.g., UE) Shall:

consider the entering condition for this event to be satisfied in a case where (e.g., when) condition CM1-1, as specified below, may be fulfilled;
consider the leaving condition for this event to be satisfied in a case where (e.g., when) condition CM1-2, as specified below, may be fulfilled; Inequality CM1-1 (Entering condition) [Device crosses a boundary in the coverage ensemble]

$$Ml 1 - Hys > Thresh 1$$

### Inequality CM1-2 (Leaving Condition)

$$Ml 1 + Hys < Thresh 1$$

The variables in the formula may be defined as follows:
Ml1 may be the WTRU (e.g., UE) location, represented by the distance between WTRU (e.g., UE) and a reference location parameter for this event not taking into account any offsets. A reference location parameter may be configured as the centre of the zone or a suitable reference point of the zone. It may be configured as the location of a TRP serving this specific zone.
Hys may be the hysteresis parameter for this event (i.e., hysteresis as defined within reportConfigNR for this event).
Thresh1 may be the threshold for this event defined as a distance from a reference location (e.g., serving TRP) to a boundary of the coverage ensemble. The WTRU (e.g., UE) may derive Thresh1 from the coverage ensemble using the information of its current location, the serving TRP location and the boundary definition according to the configuration. Boundary definition could correspond to the coverage of a RNA, TA, PLMN or even TRP coverage. Configuration may provide the information whether Thresh1 may be LOS distance (in that case, Thresh1 may be the distance of the coverage boundary on the line joining the serving TRP and UE) or a different calculation may be to be used.
Ml1 may be expressed in meters.
Hys may be expressed in the same unit as Ml1.
Thresh1 may be expressed in the same unit as Ml.

The definition of Event CM1 may also apply to CondEvent CM1.

### 3.3.4.7 Event CM2 [Device Entering a Specific Zone in the Coverage Ensemble]

### The WTRU (e.g., UE) Shall:

consider the entering condition for this event to be satisfied in a case where (e.g., when) condition CM2-1, as specified below, may be fulfilled;
consider the leaving condition for this event to be satisfied in a case where (e.g., when) condition CM2-2, as specified below, may be fulfilled;
   Inequality CM2-1 (Entering Condition) [Device Crosses into a Specific Zone in the Coverage Ensemble]:

$$Ml 1 - Hys < Thresh 1.$$

### Inequality CM1-2 (Leaving Condition):

$$Ml 1 + Hys > Thresh 1.$$

### The Variables in the Formula May be Defined as Follows:

Ml1 may be the WTRU (e.g., UE) location, represented by the distance between WTRU (e.g., UE) and a reference location parameter for this event not taking into account any offsets. The reference location may be attributed to the specific zone to which this event may be associated.
Hys may be the hysteresis parameter for this event (i.e., hysteresis as defined within reportConfigNR for this event).
Thresh1 may be the threshold for this event defined as a distance from a reference location (e.g., reference gNB/TRP location of the reference zone) to a boundary of the coverage ensemble. The WTRU (e.g., UE) may derive Thresh1 from the coverage ensemble using the information of its current location, the reference gNB/TRP location and the boundary definition according to the configuration. Boundary definition could correspond to the coverage of a RNA, TA, PLMN or even gNB/TRP coverage. Configuration may provide the information whether Thresh1 may be LOS distance (in that case, Thresh1 may be the distance of the coverage boundary on the line joining the reference TRP and UE) or a different calculation may be to be used.
Ml1 may be expressed in meters.
Hys may be expressed in the same unit as Ml1.
Thresh1 may be expressed in the same unit as Ml.

The definition of Event CM2 may also apply to CondEvent CM2.

3.3.4.8 Joint Event JJ [CM2 && A4][Device Entering a Specific Zone in the Coverage Ensemble and the Reference Cell in this Zone Becomes Better than a Threshold]

### The WTRU (e.g., UE) Shall:

consider the entering condition for this event to be satisfied in a case where (e.g., when) condition J1-1 and condition J1-2, as specified below, may be fulfilled;
consider the leaving condition for this event to be satisfied in a case where (e.g., when) condition J1-3 or J1-4, as specified below, may be fulfilled;
   Inequality J1-1 (Entering Condition) [Device Crosses into a Specific Zone in the Coverage Ensemble]:

$$Ml - Hys 1 < Thresh 1.$$

### Inequality J1-2 (Entering Condition):

$$Mn + Ofn + Ocn - Hys 2 > Thresh 2.$$

### Inequality J1-3 (Leaving Condition):

$$Ml + Hys 1 > Thresh 1.$$

### Inequality J1-4 (Leaving Condition):

$$Mn + Ofn + Ocn + Hys 2 < Thresh 2.$$

### The Variables in the Formula May be Defined as Follows:

Ml may be the WTRU (e.g., UE) location, represented by the distance between WTRU (e.g., UE) and a reference location parameter for this event not taking into account any offsets. The reference location may be attributed to the specific zone to which this event may be associated.
Hys1 may be the hysteresis parameter for this event (i.e., hysteresis as defined within reportConfigNR for this event) to be used in location conditions.
Thresh1 may be the threshold for this event defined as a distance from a reference location (e.g., reference gNB/TRP location of the reference zone) to a boundary of the coverage ensemble. The WTRU (e.g., UE) may derive Thresh1 from the coverage ensemble using the information of its current location, the reference gNB/TRP location and the boundary definition according to the configuration. Boundary definition could correspond to the coverage of a RNA, TA, PLMN or even gNB/TRP coverage. Configuration may provide the information whether Thresh1 may be LOS distance (in that case, Thresh1 may be the distance of the coverage boundary on the line joining the reference TRP and UE) or a different calculation may be to be used.
Mn may be the measurement result of the neighbouring cell, not taking into account any offsets.
Ofn may be the measurement object specific offset of the neighbour cell (i.e., offsetMO as defined within measObjectNR corresponding to the neighbour cell).
Ocn may be the measurement object specific offset of the neighbour cell (i.e., celllndividualOffset as defined within measObjectNR corresponding to the neighbour cell), and set to zero if not configured for the neighbour cell.
Hys2 may be the hysteresis parameter for this event (i.e., hysteresis as defined within reportConfigNR for this event) to be used in cell measurement conditions.
Thresh2 may be the threshold parameter for this event (i.e., a4-Threshold as defined within reportConfigNR for this event).
Ml may be expressed in meters.
Hys1 may be expressed in the same unit as Ml1.
Thresh1 may be expressed in the same unit as Ml.
Mn may be expressed in dBm in case of RSRP, or in dB in case of RSRQ and RS-SINR.
Ofn, Ocn, Hys2 may be expressed in dB.
Thresh2 may be expressed in the same unit as Mn.

The definition of Event J1 may also apply to CondEvent J1.

Joint Event J2 [OD2 && A4][Device Orientation and Distance Matching Better the Location of a Given TRP than the Serving TRP According to the Configured Thresholds]

### The WTRU (e.g., UE) Shall:

consider the entering condition for this event to be satisfied in a case where (e.g., when) conditions J2-1, J2-2 and J2-3, as specified below, may be fulfilled;
consider the leaving condition for this event to be satisfied in a case where (e.g., when) any of the conditions J2-4, or J2-5 or J2-6, as specified below, may be fulfilled;
   Inequality J2-1 (Entering Condition 1) [Device has Absolute Orientation Aligning Better the Target Cell TRP than the Serving Cell Orientation]:

$$abs ( Ou - On ) - Hys 1 < abs ( Ou - Op ) .$$

Inequality J2-2 (Entering Condition 2) [Device May be within a Suitable Distance from the Target TRP]:

$$Dn - Hys 2 < Dp .$$

### Inequality J1-3 (Entering Condition):

$$Mn + Ofn + Ocn - Hys 3 > Thresh3 .$$

### Inequality J2-4 (Leaving Condition 1):

$$abs ( Ou - On ) + Hys 1 > abs ( Ou - Op ) .$$

### Inequality J2-5 (Leaving Condition 2):

$$Dn + Hys 2 > Dp .$$

### Inequality J2-6 (Leaving Condition 3):

$$Mn + Ofn + Ocn + Hys 3 < Thresh3 .$$

The variables in the formula may be defined as follows:
Ou may be the WTRU (e.g., UE) reference orientation in absolute units estimated by the WTRU (e.g., UE) through its local sensors not taking into account any offsets.
Op may be the orientation of the serving TRP in absolute units from the WTRU (e.g., UE) as estimated by the WTRU (e.g., UE) using the location of the serving TRP received in configuration.
On may be the orientation of the neighbour TRP in absolute units from the WTRU (e.g., UE) as estimated by the WTRU (e.g., UE) using the location of the neighbour TRP received in configuration.
Hys1 may be the hysteresis parameter for orientation condition used for this event.
Dp may be the distance between WTRU (e.g., UE) location and the location of the serving TRP where the location of the serving TRP may be part of the configuration.
Dn may be the distance between WTRU (e.g., UE) location and the location of the neighbour TRP where the location of the neighbour TRP may be part of the configuration.
Hys2 may be the hysteresis parameter for distance condition used for this event.
Mn may be the measurement result of the neighbouring cell, not taking into account any offsets.
Ofn may be the measurement object specific offset of the neighbour cell (i.e., offsetMO as defined within measObjectNR corresponding to the neighbour cell).
Ocn may be the measurement object specific offset of the neighbour cell (i.e., celllndividualOffset as defined within measObjectNR corresponding to the neighbour cell), and set to zero if not configured for the neighbour cell.
Hys3 may be the hysteresis parameter for this event (i.e., hysteresis as defined within reportConfigNR for this event) to be used in cell measurement conditions.
Thresh3 may be the threshold parameter for this event (i.e., a4-Threshold as defined within reportConfigNR for this event).
Ou may be expressed in degrees with respect to a configured measurement reference. In a compatible embodiment, Ou may be expressed in radians. In a flexible approach, the unit for Ou may be configured as part of the configuration.
Op, On and Hys1 may be expressed in the same unit as Ou.
Dn may be expressed in meters.
Dp and Hys2 may be expressed in the same unit as Dn.
Mn may be expressed in dBm in case of RSRP, or in dB in case of RSRQ and RS-SINR.
Ofn, Ocn, Hys3 may be expressed in dB.
Thresh3 may be expressed in the same unit as Mn.

The definition of Event J2 may also apply to CondEvent J2.

Joint Event J3 [CM2 && A3][Device Entering a Specific Zone in the Coverage Ensemble And the Reference Cell in this Zone Becomes Better than SpCell]

### The WTRU (e.g., UE) Shall:

consider the entering condition for this event to be satisfied in a case where (e.g., when) condition J3-1 and condition J3-2, as specified below, may be fulfilled;
consider the leaving condition for this event to be satisfied in a case where (e.g., when) condition J3-3 or J3-4, as specified below, may be fulfilled;
   Inequality J3-1 (Entering Condition) [Device Crosses into a Specific Zone in the Coverage Ensemble]:

$$Ml - Hys 1 < Thresh1 .$$

### Inequality J3-2 (Entering Condition):

$$Mn + Ofn + Ocn - Hys 2 > Mp + Ofp + Ocp + Off .$$

### Inequality J3-3 (Leaving Condition):

$$Ml + Hys 1 > Thresh1 .$$

### Inequality J3-4 (Leaving Condition):

$$Mn + Ofn + Ocn + Hys 2 < Mp + Ofp + Ocp + Off .$$

The variables in the formula may be defined as follows:
Ml may be the WTRU (e.g., UE) location, represented by the distance between WTRU (e.g., UE) and a reference location parameter for this event not taking into account any offsets. The reference location may be attributed to the specific zone to which this event may be associated.
Hys1 may be the hysteresis parameter for this event (i.e., hysteresis as defined within reportConfigNR for this event) to be used in location conditions.
Thresh1 may be the threshold for this event defined as a distance from a reference location (e.g., reference gNB/TRP location of the reference zone) to a boundary of the coverage ensemble. The WTRU (e.g., UE) may derive Thresh1 from the coverage ensemble using the information of its current location, the reference gNB/TRP location and the boundary definition according to the configuration. Boundary definition could correspond to the coverage of a RNA, TA, PLMN or even gNB/TRP coverage. Configuration may provide the information whether Thresh1 may be LOS distance (in that case, Thresh1 may be the distance of the coverage boundary on the line joining the reference TRP and UE) or a different calculation may be to be used.
Mn may be the measurement result of the neighbouring cell, not taking into account any offsets.
Ofn may be the measurement object specific offset of the neighbour cell (i.e., offsetMO as defined within measObjectNR corresponding to the neighbour cell).
Ocn may be the measurement object specific offset of the neighbour cell (i.e., celllndividualOffset as defined within measObjectNR corresponding to the neighbour cell), and set to zero if not configured for the neighbour cell.
Mp may be the measurement result of the SpCell, not taking into account any offsets.
Ofp may be the measurement object specific offset of the SpCell (i.e., offsetMO as defined within measObjectNR corresponding to the SpCell).
Ocp may be the cell specific offset of the SpCell (i.e., celllndividualOffset as defined within measObjectNR corresponding to the SpCell), and may be set to zero if not configured for the SpCell.
Off may be the offset parameter for this event (i.e., a3-Offset as defined within reportConfigNR for this event).
Hys2 may be the hysteresis parameter for this event (i.e., hysteresis as defined within reportConfigNR for this event) to be used in cell measurement conditions.
Ml may be expressed in meters.
Hys1 may be expressed in the same unit as Ml1.
Thresh1 may be expressed in the same unit as Ml.
Mn, Mp may be expressed in dBm in case of RSRP, or in dB in case of RSRQ and RS-SINR.
Ofn, Ocn, Ofp, Ocp, Hys2, Off may be expressed in dB.

The definition of Event J3 may also apply to CondEvent J3.

Joint Event J4 [OD2 && A3][Device Orientation and Distance Matching Better the Location of a Given TRP than the Serving TRP According to the Configured Thresholds and the Reference Cell in this Zone Becomes Better than SpCell]

### The WTRU (e.g., UE) Shall:

consider the entering condition for this event to be satisfied in a case where (e.g., when) conditions J4-1, J4-2 and J4-3, as specified below, may be fulfilled;
consider the leaving condition for this event to be satisfied in a case where (e.g., when) any of the conditions J4-4, or J4-5 or J4-6, as specified below, may be fulfilled; Inequality J4-1 (Entering condition 1) [Device has absolute orientation aligning better the target cell TRP than the serving cell orientation]:

$$abs ( Ou - On ) - Hys 1 < abs ( Ou - Op ) .$$

Inequality J4-2 (Entering condition 2) [Device may be within a suitable distance from the target TRP]:

$$Dn - Hys 2 < Dp .$$

### Inequality J4-3 (Entering Condition):

$$Mn + Ofn + Ocn - Hys 3 > Mp + Ofp + Ocp + Off .$$

### Inequality J4-4 (Leaving Condition 1):

$$abs ( Ou - On ) + Hys 1 > abs ( Ou - Op ) .$$

### Inequality J4-5 (Leaving Condition 2):

$$Dn + Hys 2 > Dp .$$

### Inequality J4-6 (Leaving Condition 3):

$$Mn + Ofn + Ocn + Hys 3 < Mp + Ofp + Ocp + Off .$$

The variables in the formula may be defined as follows:
Ou may be the WTRU (e.g., UE) reference orientation in absolute units estimated by WTRU (e.g., UE) through its local sensors not taking into account any offsets.
Op may be the orientation of the serving TRP in absolute units from the WTRU (e.g., UE) as estimated by WTRU (e.g., UE) using the location of the serving TRP received in configuration.
On may be the orientation of the neighbour TRP in absolute units from the WTRU (e.g., UE) as estimated by WTRU (e.g., UE) using the location of the neighbour TRP received in configuration.
Hys1 may be the hysteresis parameter for orientation condition used for this event.
Dp may be the distance between WTRU (e.g., UE) location and the location of the serving TRP where the location of the serving TRP may be part of the configuration.
Dn may be the distance between WTRU (e.g., UE) location and the location of the neighbour TRP where the location of the neighbour TRP may be part of the configuration.
Hys2 may be the hysteresis parameter for distance condition used for this event.
Mn may be the measurement result of the neighbouring cell, not taking into account any offsets.
Ofn may be the measurement object specific offset of the neighbour cell (i.e., offsetMO as defined within measObjectNR corresponding to the neighbour cell).
Ocn may be the measurement object specific offset of the neighbour cell (i.e., celllndividualOffset as defined within measObjectNR corresponding to the neighbour cell), and set to zero if not configured for the neighbour cell.
Mp may be the measurement result of the SpCell, not taking into account any offsets.
Ofp may be the measurement object specific offset of the SpCell (i.e., offsetMO as defined within measObjectNR corresponding to the SpCell).
Ocp may be the cell specific offset of the SpCell (i.e., celllndividualOffset as defined within measObjectNR corresponding to the SpCell), and may be set to zero if not configured for the SpCell.
Off may be the offset parameter for this event (i.e., a3-Offset as defined within reportConfigNR for this event).
Thresh3 may be the threshold parameter for this event (i.e., a4-Threshold as defined within reportConfigNR for this event).
Ou may be expressed in degrees with respect to a configured measurement reference. In a compatible embodiment, Ou may be expressed in radians. In a flexible approach, the unit for Ou may be configured as part of the configuration.
Op, On and Hys1 may be expressed in the same unit as Ou.
Dn may be expressed in meters.
Dp and Hys2 may be expressed in the same unit as Dn.
Mn, Mp may be expressed in dBm in case of RSRP, or in dB in case of RSRQ and RS-SINR.
Ofn, Ocn, Ofp, Ocp, Hys3, Off may be expressed in dB.

The definition of Event J4 may also apply to CondEvent J4.

### Additional Examples of Joint Events

The previous subsections have provided some key example events which combine the measurement quantities over radio measurements and non-radio measurements to suitable events which can be used to achieve zero interruption in mobility by triggering conditional (re-) configurations such as beam failure recovery, conditional handover, conditional PSCell change/addition etc. These examples can be used to create additional events jointly over radio measurement and non-radio measurement quantities which can identify the target scenario in a very precise manner and choose the most suitable beam/cell/TRP/network node (e.g., gNB) in a fast manner thanks to these combinations.

In the examples of joint events, event A3 and A4 have been combined with non-radio measurement quantities combing orientation, distance, or zone entrance. In the same vein, event A5 can be combined with non-radio measurement quantities.

The examples of joint events J1, J2, J3 and J4 can further be combined with speed/velocity condition as used in event V1 to segregate high speed and low speed scenarios and use suitable beams/cells/TRPs accordingly.

For devices with rotation only concerns, event R1 or event 01 can be combined with classic measurement quantity events (A3, A4 and A5) etc. to create rotation focused conditional events which can then trigger suitable (re-)configurations.

### Reporting for Non-Radio Measurements

If measurement objects are defined for non-radio measurements, the current 3GPP reporting framework may be fully applicable to the newly introduced non-radio measurements. According to the reporting configuration attributes whether periodic or event triggered, a WTRU (e.g., UE) can provide the non-radio measurements suitably filtered according to the quantity configuration and/or provide this report to the network with the indication of measurement identity which serves as the reference for the reporting.

For the alternative embodiment where measurement identities can be configured by the network without measurement object, the reporting for non-radio measurements may be based upon the reporting configuration. The post-processing or filtering over non-radio measurements may be not applied or defined a-priori without a quantity configuration.

### Proactive Beam Failure Recovery Based Upon Non-Radio Measurements

According to embodiments, a method is proposed that may target recovering from abeam failure event with minimal outage and interruption in a deterministic manner.

As cellular networks may be planned networks, the network may have very precise knowledge of its deployment of cells, and the beams within those cells in terms of coverage ensemble attributes such as the locations (reference location) of cells or transmission points (TRPs), potential spatial directions of transmission defined for example by azimuth, elevation angles and location coordinates of the TRPs, beam width information such as 3-dimensional (3D) beam width information, for example in horizontal and vertical directions, transmission range information, coverage shape information including for example location coordinates of points that constitute the coverage border of a beam, cell or TRP. What the network may not know in advance may be the future movement (translational or rotational) of the device, for example how a specific WTRU (e.g., UE) may move from one cell/beam to another cell/beam. As a matter of fact, this information may be in general not even known to a WTRU (e.g., UE) itself. Similarly, in general, a WTRU (e.g., UE) may have no information of network coverage ensemble as defined herein, or deployment in terms of cells and beams and the geographic areas where these cells/beams may be active. The terms coverage ensemble and network deployment may be used interchangeably hereinafter. The proposed approach may target using the known deployment of cells/beams from the networks by network providing a finite snapshot of network deployment to a WTRU (e.g., UE) along with suitable coordinates binding the cells/beams to geographic locations and orientations. A WTRU (e.g., UE) may use the information from local sensors and interfaces to extract its current geographic parameters and mobility parameters. The WTRU (e.g., UE) geographic parameters may include any of, for example, the WTRU (e.g., UE) location information such as absolute position, relative positions to objects or other geographical markers, relative position to reference location of serving or neighboring cell/TRP(s). The WTRU (e.g., UE) mobility parameters may include any of, for example, the WTRU (e.g., UE) mobility route information, the WTRU (e.g., UE) speed, direction, angular rotation, etc. The WTRU (e.g., UE) may use any of its geographics parameters, its mobility parameters, its capability information together with the coverage ensemble information to determine a suitable candidate beam from the network provided configuration. This may ensure a proactive beam recovery in case of beam failure.

According to embodiments, a WTRU (e.g., UE) may provide the assistance information (details in the following paragraphs) to the network node (e.g., gNB). The network node (e.g., gNB) may use this information to prepare proactive beam recovery configuration including coverage ensemble information and may provide this to the WTRU (e.g., UE). In the event of a compromised quality of a serving beam, the WTRU (e.g., UE) may determine a suitable candidate beam, for example, as a function of any of: its current coverage ensemble configuration, its geographic parameters, its mobility parameters, its capability, and other data available through its local sensors and potentially combined with other radio measurements, may validate and may perform beam recovery with the selected candidate. The assistance information may be a key element in the proposed approach which in the first place may be transmitted to the network node (e.g., gNB) and may be used to prepare a suitable configuration for the target WTRU (e.g., UE). A novel element of the configuration of the beams may be their association or mapping to the WTRU (e.g., UE) geographic coordinates or the data from sensors plus other radio measurements. The network may provide this configuration to a WTRU (e.g., UE). A WTRU (e.g., UE) may use the information from local sensors potentially combined with radio measurements to determine a suitable candidate beam according to the configured mapping from the network. The triggering criteria for the determination of a suitable candidate beam, and the triggering criteria for the replacement of a current serving beam by a suitable candidate beam may be described in hereabove. In the following, the assistance information may be defined broadly and (e.g., the key) steps of the proposed proactive beam recovery procedure may be described.

The assistance information from the WTRU (e.g., UE) can be broadly categorized in two groups, termed as radio signal measurement based data and non-radio signal measurement-based data. In this disclosure, radio signal measurement based data may simply be denoted measurement based data and non-radio-signal measurement based data may be denoted non-measurement-based data. One group may comprise (e.g., all) the information that can be estimated, measured, determined with or without post-processing over the signals received from the radio interface where mobility may be being considered. This group may be termed as measurement-based (e.g., radio measurement-based) data. This may comprise any of: receiving, measuring, and processing the reference signals on the physical layer, MAC information elements, RRC messages received from the network, or the information received at higher layers. The corresponding measurements quantities may be in the form of RSRP, RSSI, RSRQ, SNR, or SINR.

The second group may comprise (e.g., all) the information that may not be extracted from the network signaling. This group may be termed as non-measurement-based data. One sub-group in non-measurement-based data may comprise the WTRU (e.g., UE) capability and implementation details covering any of: its antenna panels, respective field-of-views for those panels, transceivers and power characteristics, switching delays, simultaneous operation for the panels, etc. The second sub-group in non-measurement-based data may encompass (e.g., all) the information extracted or measured through local sensors and interfaces other than the radio interface where mobility may be being considered, such as the WTRU (e.g., UE) geographic parameters for example, the WTRU (e.g., UE) location information such as absolute position, relative positions to objects or other geographical markers, reference location of serving or neighboring cell/TRP(s). The examples of local sensors may be positioning sensors, gyroscopes, accelerometers, speed monitoring sensors etc. The interfaces other than the considered radio interface could be wired interfaces like ethernet, wireless interfaces like Bluetooth, WiFi or any other proprietary wired or wireless interfaces. Another sub-group in non-measurement-based data may comprise the mobility metrics and configurational triggers. The examples of mobility metrics could be the speed (translational or/and rotational), direction (translational or/and rotational), velocity, trajectory, or/and history of mobility to name a few. The relevant configurational triggers helpful for mobility management and providing the suitable configuration could come from situational or contextual information—e.g., a vehicular device (or the devices inside) starting its trajectory to a destination where both the start and the trajectory could be very important from the configuration perspective. Another example can be the start of a network game from an AR/VR device potentially including user profile which may incorporate or provide the user behavior in terms of rotations during the game. Such parameters may be updated by a WTRU (e.g., UE) while having received some BFR configuration from the network node (e.g., gNB). The network node (e.g., gNB) may update the BFR configuration upon receiving the updated assistance information from a WTRU (e.g., UE) or other factors.

In some cases, overlapping may occur i.e., similar information may be available in measurement-based and non-measurement-based group. One example may be the positioning, where the network may provide some positioning information (measurement-based) while the WTRU (e.g., UE) may be equipped with a local positioning sensor which may extract the positioning information from any of the satellite systems. In such a case, one or the other can be used, or both information sets can be combined to achieve better accuracy, granularity or information quality.

After having defined the assistance information, the (e.g., key) steps of the proposed approach may be summarized here and detailed later:
The WTRU (e.g., UE) may provide assistance information to the network node (e.g., gNB). This assistance information incorporates and streamlines the potential information which a WTRU (e.g., UE) may measure and obtain through the signals received from the network, or it can obtain through other interfaces or extract from its local sensors. It may be possible for a WTRU (e.g., UE) to update its assistance information, at least for certain parameters under certain conditions.
The network node (e.g., gNB) may provide the proactive beam recovery configuration in response to the WTRU (e.g., UE) assistance information. This configuration may be based upon the network deployment of cells, TRPs, beams and WTRU (e.g., UE) provided assistance information. The configuration preparation can take into account any historical data about the WTRU (e.g., UE) parameters, applications usage, WTRU (e.g., UE) subscription status etc. The configuration preparation can use the artificial intelligence and machine learning algorithms to prepare the configuration suitable to WTRU (e.g., UE) in a predictive manner using (e.g., all) the network and WTRU (e.g., UE) data.
The Proactive beam recovery configuration may comprise a set of candidate beams for recovery and the mapping of these candidate beams to suitable parameters which encompass measurement-based and non-measurement-based data. As an example, the candidate beams may be mapped to active zones (in terms of position/location) and WTRU orientation in terms of WTRU antenna panels features such as angular span etc.
After a mobility event (resulting from device mobility or mobility in the environment) leading to compromised beam quality or beam failure, the WTRU (e.g., UE) may use the relevant information from radio measurements, non-radio measurements, or combined and processes them according to the configured thresholds. It identifies the suitable beam/cell from the network configured mapping and may perform the procedure of beam failure recovery with this derived candidate beam. In an alternative embodiment, the WTRU (e.g., UE) may evaluate triggering criteria for the evaluation of suitable beams in a case where (e.g., when) the triggering criteria for the evaluation of suitable beams replacement i.e., beam failure detection criteria as defined hereabove may be fulfilled. The WTRU (e.g., UE) may identify a (i.e., one or more) suitable beam, according to the criteria for a candidate beam to be deemed suitable beam as defined hereabove. The beam failure detection criterion for the proposed embodiment can be relaxed, i.e., the threshold can be set to higher value so that beam failure may be declared fast and the proposed recovery mechanism can kick in faster replacing the degrading beam. This may allow the proactive beam recovery to declare beam failure faster and recover to deterministically known beams in a faster manner leading to minimization of outage.
The WTRU (e.g., UE) may evaluate triggering criteria for the evaluation of candidate beams as defined hereabove. The WTRU (e.g., UE) may identify one or more candidate beams as recovery beams, in a case where (e.g., when) the criteria for beam failure recovery as defined hereabove may be fulfilled. The WTRU (e.g., UE) may inform the network of the selected one or more candidate beams. The recovery procedure may involve transmitting RACH on the selected beam.
In a fully network control scheme, the WTRU (e.g., UE) may report the measurement results in terms of one or more suitable candidate beams and zero or more serving beam for replacement to the network. The network may confirm to the WTRU (e.g., UE) the new serving beam to be used.

This section may provide a grouping of the WTRU (e.g., UE) assistance information in two groups: one termed as measurement-based data and the other termed as non-measurement-based data. The assistance information can be grouped in different manners. One embodiment compatible to the proposed approach can categorize the assistance information in radio-measurement-quantity-based-data and non-radio-measurement-quantity-based-data. The first group of radio-measurement-quantity-based-data can comprise (e.g., all) radio measurements that can be configured by the radio network. This may comprise (e.g., all) the measurements on NR, E-UTRAN, UTRAN and WiFi etc. The measurements pertaining to different RATs can be the existing measurement quantities or the support for new measurement quantities can be introduced. The second group of non-radio-measurement-quantity-based-data groups (e.g., all) the remaining assistance information that may be useful to minimize interruptions during the beam failure recovery process. The information elements in this group may include the parameters and quantities that a WTRU (e.g., UE) may be capable of providing based upon other local interfaces and local sensors etc. A sub-group in this non-radio-measurement-quantity-based-data can include a set of parameters and quantities related to WTRU (e.g., UE) capability and specific implementation details (including but not limited to antennas, panels, detailed implementation on antenna panels—e.g., field of view, power characteristics, radiation patterns, architecture details as how the transceivers link to different panels, beam steering capabilities including digital, analog/phase-shifts and hybrid based, transition time for beam steering and panel switching delays, etc.). The mobility relevant triggers helpful for mobility management coming from situational or contextual information—e.g., a vehicular device (or the devices inside) starting its trajectory to a destination, or the trigger about the start of a network game from an AR/VR device potentially including user profile could also be part of the non-radio-measurement-quantity-based-data.

In a different yet compatible grouping of assistance information, three groups can be defined as radio-measurement-quantity-based-data, non-radio-measurement-quantity-based-data and UE-capability-and-implementation-based data. In this categorization, radio-measurement-quantity-based-data may be as defined previously. Non-radio-measurement-quantity-based-data may comprise (e.g., all) the measurements which may not be part of the first group and could be made through local interfaces and local sensors, plus the mobility triggers providing situational and contextual information. The third group may include a set of parameters and quantities related to WTRU (e.g., UE) capability and specific implementation details.

According to embodiments, the network (e.g., base station) may broadcast coverage ensemble information. A New coverage ensemble system information block (SIB) may be specified. It may be understood that in this case, the coverage ensemble information broadcasted by a cell or a TRP may be configured to reflect the local deployment environment of the cell or TRP broadcasting the coverage ensemble. For example, a PLMN may be subdivided into more than one coverage ensemble which may overlap or may be disjointed. A coverage ensemble may be associated with an area denoted here coverage ensemble area. A coverage ensemble area may correspond to one or more cells, a RAN notification area (RNA), a tracking area (TA), a PLMN, etc. The WTRU (e.g., UE) may receive the coverage ensemble area configuration information in the coverage ensemble SIB, or thought a new SIB dedicated to coverage ensemble area signaling that may be denoted here coverage ensemble area SIB. The WTRU (e.g., UE) may receive the coverage ensemble area information through dedicated RRC signaling (e.g., RRC reconfiguration message). Upon detection of change in coverage ensemble area, the WTRU (e.g., UE) may re-acquire a coverage ensemble for its current location, for example by re-acquiring the coverage ensemble SIB, or through dedicated RRC signaling exchange with the network (e.g., base station). The WTRU (e.g., UE) detection of change in coverage ensemble area may comprise any of the followings:
A change in serving cell or (re)selection to a cell that may not belong to the current coverage ensemble area.
A (re)selection to an RNA that may not belong or may not correspond to the current coverage ensemble area.
Execution of an RNA update procedure, or transmission of an RNA update message to the network (base station).
A (re)selection to a TA that may not belong, or ensemble that may not correspond to the current coverage ensemble area.
Execution of a TA update procedure, or transmission of a TA update message to the network (core network).
A (re)selection to a PLMN that may not belong, or ensemble that may not correspond to the current coverage ensemble area.

The coverage ensemble may be defined at different suitable granularities. The granularity of the coverage ensemble may be part of the coverage ensemble configuration. In one embodiment, the coverage ensemble may be defined at cell level and the information of geographic coverage from different gNBs/TRPs may be indicated to WTRUs (e.g., UEs) with suitable signaling. The cell level coverage may be useful for different hand-over and cell change procedures. The coverage ensemble granularity may be reflected in the form of zones which represent the level of granularity. A zone can be attributed to any (e.g., each) RNA, TA, or PLMN. For cell level procedures, the coverage ensemble zones can have the cell level granularity. For beam level procedures where for example a WTRU (e.g., UE) may (e.g., need to) track, maintain or switch beams, the coverage ensemble granularity can be at beam level, and the zones in such a coverage ensemble be attributed to different beams.

The zones in the coverage ensemble can be indicative of the geographic area which may correspond to a set of reference signals. For beam level zones, in one embodiment, any (e.g., each) zone can indicate the coverage area for an SSB beam. In another beam level zone design, any (e.g., each) zone can indicate the coverage area for an SSB beam or a CSI-RS beam where SSB/CSI-RS beam may be the coverage for the corresponding SSB/CSI-RS signals. For cell level zones, the zone may indicate the area where this cell has sufficient coverage. The cell level zone can group all the SSB/CSI-RS zones associated with a given cell and it may represent the area where any of the SSB/CSI-RS signals for this cell can be received with a known/configured quality. The zone representation can be extended to larger granularities for RNA, TA or PLMN based coverage zones.

Any (e.g., each) zone can have an identity where the identity can be indicated (e.g., explicitly) as part of the zone configuration. In another embodiment, the zone identity can be a deterministic combination of the certain parameters as a function of zone granularity. These identities can be modulated with some configuration parameters. As an example, a beam level zone identity can be a combination of cell identity and beam identity (SSB or CSI-RS). The cell level zone identity can be the cell identity or a deterministic modification of the cell identity by combining with some other parameters. The same can be used for zones mapped to represent the coverage for RNA, TA, PLMN etc.

A WTRU (e.g., UE) can derive the information from radio measurements and non-radio measurements to aid in mobility procedures. As one example, the information derived from non-radio measurements comprising of geographic coordinates and orientation can let the WTRU (e.g., UE) derive its current zone. More specifically, the WTRU (e.g., UE) may be configured by the network with measurement configuration wherein the conditional events, event CM1 or event CM2 (as detailed in section 3.3), may be configured. In a case where (e.g., when) the relevant conditions for these events may be fulfilled, the WTRU (e.g., UE) may determine the change of its current zone. The WTRU (e.g., UE) may determine its new zone, which may allow it to derive the suitable beam from the coverage ensemble corresponding to this updated zone, validate the beam from radio signal measurements, and initiate the beam recovery procedure. The same can be achieved by network configuring the WTRU (e.g., UE) with events which have conditions composite over radio and non-radio measurement quantities. These events may be defined as J1, J2, J3 and J4 in section 3.3.4.

### Procedural Details for Proactive Beam Recovery

A WTRU (e.g., UE) can have limited discovery of neighboring beams around it for various reasons and at any moment it can find itself in a situation where it had not discovered a-priori the detectable beams in the vicinity. This situation can result if a WTRU (e.g., UE) makes a fast translational movement, or it undergoes a large rotation, or a combination of the former two. This can also be due to a limited number of antennas, antenna panels, transceivers, or stringent requirements on power consumption. These situations and/or aspects result in limited neighboring beams being discovered and reported by a WTRU (e.g., UE) to the network. With the legacy beam management and beam recovery procedures, this may limit the configuration from the network where the network may configure the surrounding beams for potential recovery in case of failure of current serving beam(s). A missing beam recovery configuration for the beams that a WTRU (e.g., UE) finds detectable in the vicinity may result in inability of beam failure procedure to let WTRU (e.g., UE) recover to these beams. This may ultimately result in radio link failure as both beam management and radio link monitoring may be running in parallel at a WTRU (e.g., UE). Radio link failure may (e.g., then) result in WTRU (e.g., UE) doing the cell search, and RRC configuration procedures from the scratch which may be highly time consuming and detrimental for ongoing traffic flows.

### The Network Configuration:

According to embodiments, a WTRU (e.g., UE) can provide assistance information to the network node (e.g., gNB). This information may comprise the measurement-based data and non-measurement-based data as detailed earlier. Based upon the received assistance information, the base station can provide a WTRU (e.g., UE) a set of candidate beams around a UE's geographic coordinates along with a mapping which associates the candidate beams to the new geographic coordinates. The updated geographic coordinates can be any subset of parameters from the assistance information. These parameters can be taken to be outside of assistance information but for which the network node (e.g., gNB) knows that WTRU (e.g., UE) may be able to have them known through its local sensors or other interfaces. In one simple example, the mapping of candidate beams can be provided with respect to their orientation indication. This orientation indication can be in the form of angular coverage with respect to a suitable reference beam. The angular coverage can be defined using azimuthal angles, elevation angles or a combination of the two. The reference beam indication may be part of the configuration. The reference beam can be defined as an SSB beam or a CSI-RS beam. The reference beam can be the actual beam through which the network may be serving a WTRU (e.g., UE). Instead of reference beam, reference direction can be specified using other approaches, e.g., geographical north or some other reference which may be understandable to both the network and a WTRU (e.g., UE). In one example, the orientation information may be given with respect to one or more configured transmission configuration indication (TCI) states where a TCI state may contain QCL reference information with a DL or UL beam/RS. In another example, the candidate beams can be provided mapping against the position and the orientation, both noted in suitable coordinates and in appropriate quantized forms.

For any (e.g., each) beam in the configured set, in addition to its angular span around a WTRU (e.g., UE), the network node (e.g., gNB) may provide the relevant parameters to initiate contention free RACH access within that beam. This may include the RACH parameters, e.g., RACH preamble sequence identity, RACH duration, power ramping parameters, the parameters related to RACH occasions associated to the indicated beam, etc. The configuration may provide RACH parameters for 4-step RACH, 2-step RACH or both. In addition, prioritized RACH access parameters may be specified as part of the configuration to speed up beam failure recovery.

Another optimization could be to design special search spaces for beam failure recovery. In one embodiment, these search spaces may have higher periodicity for fast network feedback. They can also be made simpler to reduce WTRU (e.g., UE) decoding complexity for BFR message exchanges.

Another method can be to provide the configuration of UL and DL bandwidth parts which should be activated and used for beam failure recovery procedures. These can be different from active BWP pre-BFD event.

The configuration may also include the conditions under which the configuration stays valid. The configuration may have a timer and the validity may expire upon the expiry of this timer. Another configuration release condition may be associated with the mobility, i.e., if the configured device moves away from its last known position/location by more than a configured threshold, it may release the proactive configuration. For this purpose, suitable zones may be created by configuration. The WTRU (e.g., UE) may keep track of its zone. The exit condition may specify in a case where (e.g., when) to release the configuration. One example may be if the WTRU (e.g., UE) just moves out of its current zone. In another example, the configuration may be valid in the current zone and direct neighbors having overlapping boundaries. In this case, if the WTRU (e.g., UE) moves out of direct neighbor zones, it may release the proactive configuration. Another example where the configuration release condition may be associated with the device's timing advance value (e.g., with the serving gNB), e.g., if the device moves and the change in the timing advance may be above a configured threshold, the device may be configured to release the current active Proactive configuration. More broadly, any suitable combination of parameters from the assistance information can be used to define the validity conditions and the release conditions.

In another embodiment, one or more proactive configurations may be given to the device. The mapping/association of a configuration with a zone, a location, or a timing advance value/range may be given to the device. The device may select the configuration based on the tracking of the associated metric (zone, location, or timing advance, etc.).

For future systems based upon ultra-massive MIMO having the capability of deploying thousands of beams per TRP, to contain the overhead the network deployment of beams can follow certain rules and can be provided in a compact form. In one example, the beam deployment can follow a pattern in azimuthal and elevation dimensions. A set of patterns may be known in tabular forms or through formulae. The network may choose a suitable pattern for its deployment according to its requirements in a given geographic area. For such cells and beam deployments, the network may provide the compact form of deployment pattern to the WTRU (e.g., UE) as part of the proactive beam recovery configuration. The configuration may include the positions of TRPs in suitable coordinates. A WTRU (e.g., UE) receiving such configuration may determine the nearest TRPs for any location and may determine the beam ensemble using the pattern indication. The parameters for any (e.g., each) constituent beam, its identity, associated reference symbols parameters, RACH occasions, RACH preambles and other parameters can also be conveyed to WTRU (e.g., UE) as part of the configuration in suitable compact form.

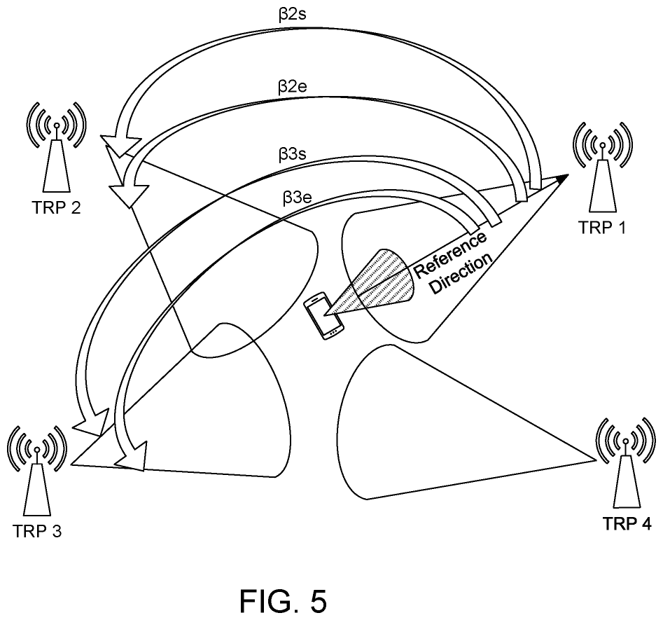

An example configuration may be shown in FIG. 5 for a WTRU (e.g., UE) communicating with TRP 1. This figure shows the configuration comprising of indication of reference direction with the current beam, and the neighboring beams with their angular spans. In this example figure, a beam from TRP 2 may be configured with its span marked with respect to the reference (beam) direction as a start angle (β2s) and an end angle (β2e). Similarly, the figure shows the start and end angles for an exemplary beam from TRP 3 as β3s and β3e. For any (e.g., each) configured beam, the network node (e.g., gNB) may provide the RACH related details to allow contention free RACH access (CFRA) within that beam. The same configuration information can be provided by providing one angle from the reference direction/beam to the center of a candidate beam, and in addition providing the beam width for any (e.g., each) beam. This can be further simplified if the beam width may be same for any (e.g., each) beam, and then one single beam width may be provided for any (e.g., each) candidate beam.

### WTRU (e.g., UE) Procedure:

In a case where (e.g., when) there may be comprised quality of the beam to which WTRU (e.g., UE) may be attached, the PHY layer may report beam failure indication (BFI) to the MAC layer. The PHY layer may generate BFI indications in a case where (e.g., when) the reference symbols associated to a beam fall below a configured threshold. These conditions could be defined on SSB, CSI-RS, or a combination of both. For ultra-massive MIMO, there may potentially be new reference symbol structures. One implementation can be in the form of layered architecture where narrow beams may be overlaid over wider beams. There may be multiple layers of such varying width beams. The beam failure conditions can be suitably defined and configured using the existing reference symbols or the new reference symbols defined for emerging networks having large number of beams and suitable thresholds to be evaluated in view of those reference symbols.

If a WTRU (e.g., UE) undergoes beam failure, for example as a result of a fast rotation, a WTRU (e.g., UE) may get the locally available information of amount of rotation from local sensors and/or gyroscope. It may compute its fresh orientation using the rotation information and the network indicated reference beam/direction. The network configuration may indicate a variety of beams with their angular coverages. The WTRU (e.g., UE) may determine the suitable beam with respect to its locally determined orientation after the rotation event. This may let a WTRU (e.g., UE) know precisely which beam it should have line-of-sight connection with respect to its new orientation. As a result, a WTRU (e.g., UE) may not need to perform blind decoding and cell searches to find SSB beams and later perform the lengthy beam refinement procedures to reach a suitable active connection.

For example, after having established the suitable beam from the network node (e.g., gNB) provided configuration, a WTRU (e.g., UE) may use the configured parameters to be used for beam recovery with respect to its newly determined beam. It may send contention free RACH with the configured RACH parameters over the configured RACH resources linked to the determined suitable beam.

### Message Sequence Chart for Proactive BFR—Events on Radio Measurements

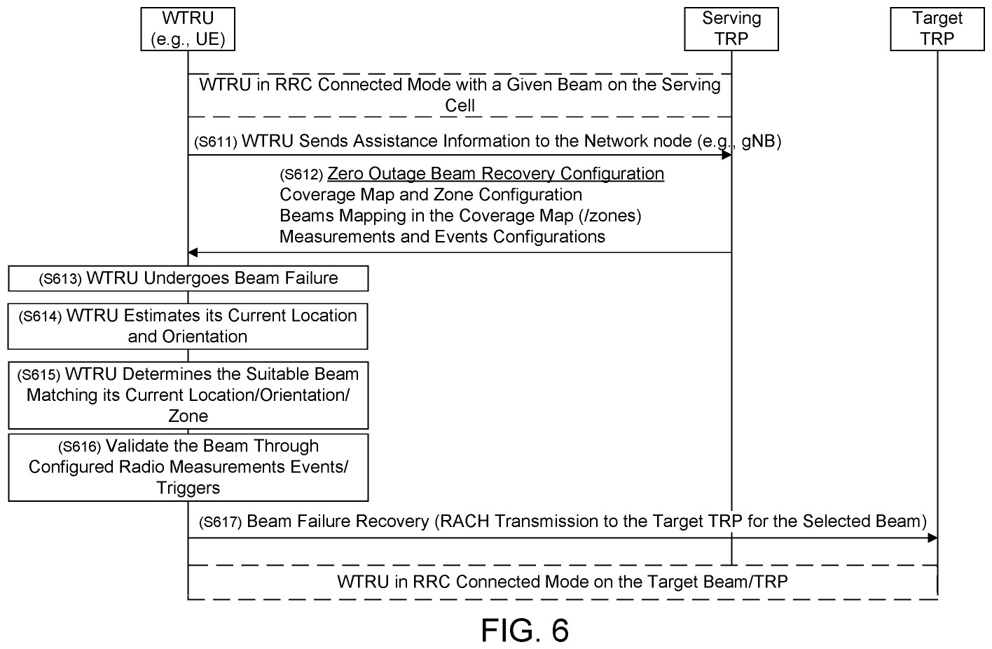

FIG. 6 shows a message sequence diagram for message exchanges between a WTRU (e.g., UE) and the network where the WTRU (e.g., UE) may be undergoing beam failure. The WTRU (e.g., UE) may send the assistance information to the network (S611). The assistance information may help the network to prepare the suitable proactive beam recovery configuration.

The WTRU (e.g., UE) may receive proactive beam recovery configuration provided by the network (S612). In a case where (e.g., when) the WTRU (e.g., UE) undergoes beam failure (S613), it may estimate its current location and orientation through local sensors (S614). Such information can be combined with radio measurement quantities. The WTRU (e.g., UE) may determine the suitable recovery beam from its received configuration which may correspond to its estimated location/orientation (S615). After validating the beam (S616), for example, through suitably configured thresholds, the WTRU (e.g., UE) may initiate the beam recovery procedure over the validated beam (S617).

Although the assistance information can be used by the network to prepare suitable proactive beam recovery configuration, it may not be mandatory. The network can prepare the configuration without having received any assistance information primarily relying on its knowledge of deployment network. The configuration can be refined further with the use of network statistics, artificial intelligence and machine learning algorithms applied to the historic data.

### Message Sequence Chart for Proactive BFR Joint Events on Radio and Non-Radio Quantities

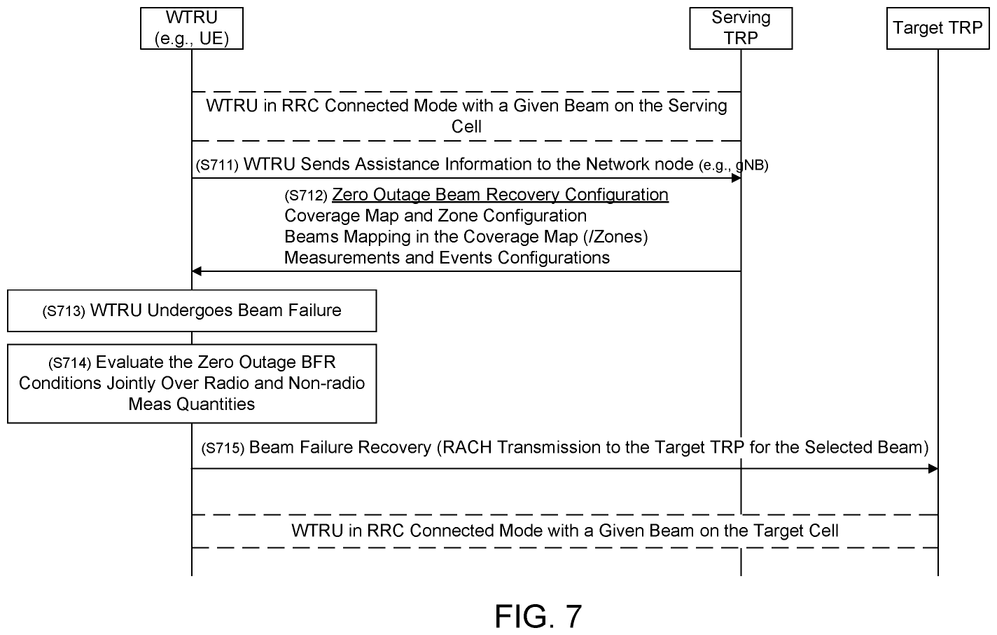

FIG. 7 shows a message sequence diagram for message exchanges between a WTRU (e.g., UE) and the network where the WTRU (e.g., UE) may be undergoing beam failure. Most of the message exchanges (S711 to S713) in this sequence chart may be similar to the previous example described in FIG. 6. A (e.g., key) change may be the use of joint events on the radio and non-radio measurement quantities which may be used to trigger the beam recovery procedure on the suitable candidate beam. The network may provide the configuration of joint radio and non-radio measurement triggers and events to the WTRU (e.g., UE) as part of the proactive beam recovery configuration. The examples for these joint events may be J1, J2, J3 and J4 as detailed in section 3.3.4. Upon undergoing beam failure, the WTRU (e.g., UE) may evaluate the configured conditions (or joint events) (S714) and if the conditions are met for a candidate beam, the WTRU (e.g., UE) may initiate the Proactive beam recovery procedure with the successful candidate beam (S715).

### Message Sequence Chart for Proactive BFR—Broadcast Coverage Ensemble and Joint Events on Radio and Non-Radio Quantities

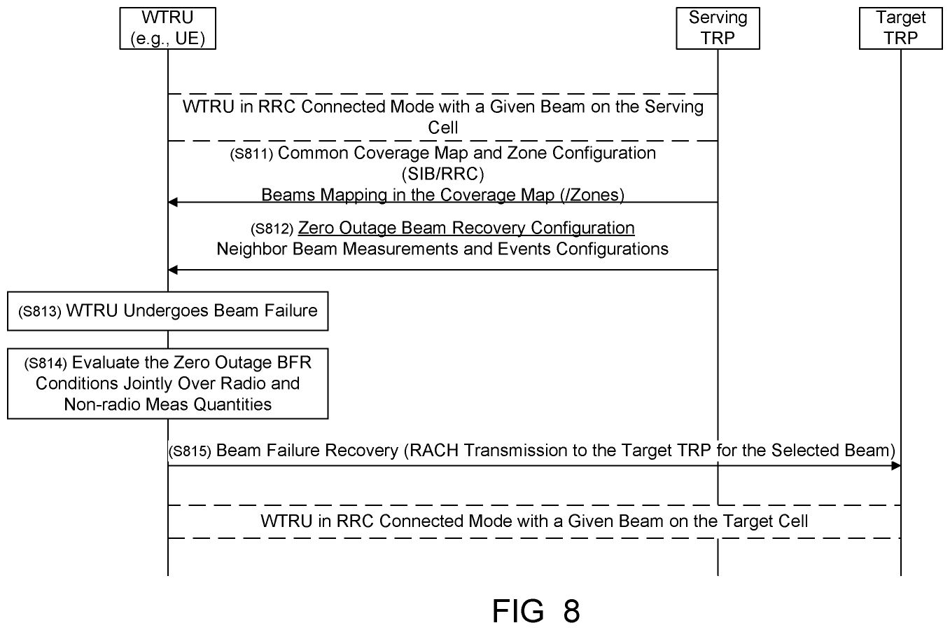

FIG. 8 shows a message sequence diagram for message exchanges between a WTRU (e.g., UE) and the network where the WTRU (e.g., UE) may perform the proposed Proactive beam failure recovery procedure after undergoing beam failure. This sequence chart shows the embodiment where the network may be transmitting coverage ensemble as broadcast information. This broadcast coverage ensemble may be transmitted by a special SIB. The WTRU (e.g., UE) may receive and may store (for example locally) the coverage ensemble (S811). The WTRU (e.g., UE) may receive proactive beam recovery configuration provided by the network (S812). In a case where (e.g., when) the WTRU (e.g., ULE) undergoes beam failure (S813), it may estimate its current location and orientation through local sensors. Such information can be combined with radio measurement quantities. The WTRU (e.g., UE) may evaluate the triggering conditions and events to determine the suitable recovery beam from its received configuration which may correspond to its estimated location/orientation. After validating the beam through suitably configured joint events combining the radio and non-radio measurement quantities (S814), the WTRU (e.g., UE) may initiate the beam recovery procedure over the validated candidate beam (S815).

### Flow Chart for Proactive Beam Recovery Procedure

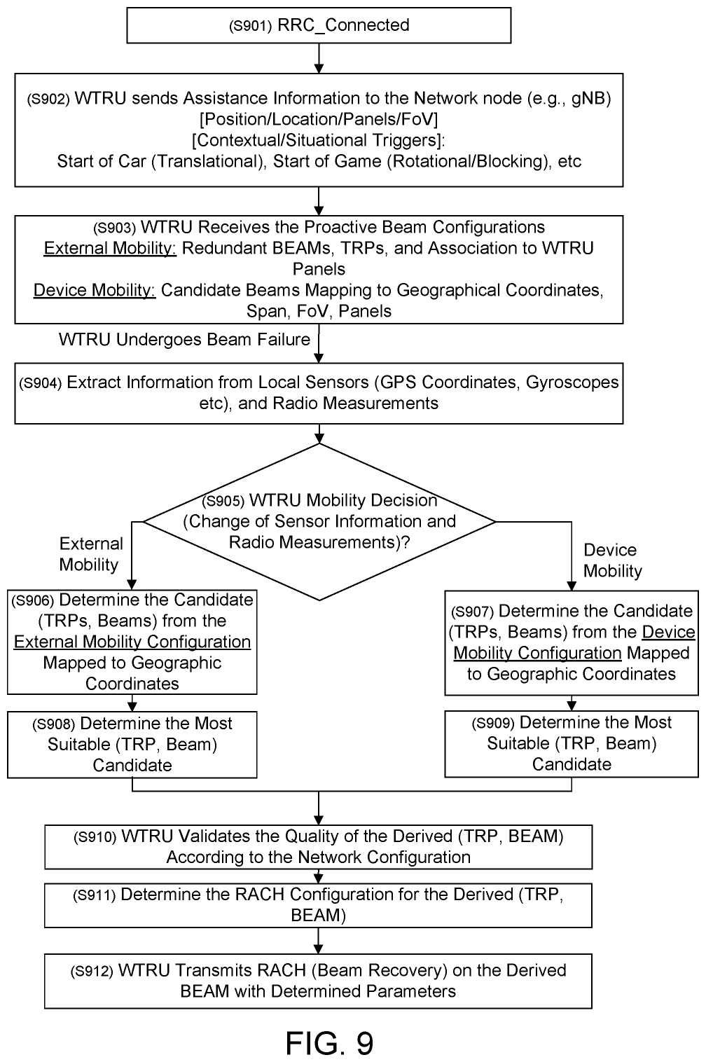

FIG. 9 shows a flow chart for the proposed Proactive beam recovery procedure.

For a WTRU (e.g., UE) in a connected (e.g., RRC_CONNECTED) state (S901), it may send the advanced assistance information to the network/network node (e.g., gNB) (S902). This information from the WTRU (e.g., UE) may include the measurement-based information and non-measurement-based information. The parameters and elements for both broad categories within assistance information were detailed earlier. The assistance information may carry the information from the WTRU (e.g., UE) situation/context and the applications running which may require uncompromised mobility. This may include some triggers which may indicate that potentially device may undergo mobility situations leading to outages. The examples of such triggers can be a car starting to move (which may result in high translational mobility), head-mounted display (HMD) device or other AR/VR gadgets indicating the start of a virtual/mixed reality game (where rotational mobility and mobile blockers may lead to outages) etc.

Based upon the assistance information, the network node (e.g., gNB) may provide suitable configuration to WTRU (e.g., UE) for beam recovery (S903). This configuration may comprise the candidate beams and suitable mapping of these candidate beams to geographic coordinates (including but not limited to locations/zones/spans etc.). The network configuration may comprise the parameters and thresholds for the WTRU (e.g., UE) to apply to its updated geographic coordinates (e.g., zone/location/position and span) using local sensors and interfaces, so as to pick the suitable beam from the suitable TRP, for example, using the configured mapping table. The configuration may include at least two sets of configurations, one to handle the device mobility where the device may be undergoing translational and rotational movements, and the other configuration focusing on the external mobility where the interruptions may be originated from the environment and not the result of direct device mobility. As an example, the external mobility resulting from mobile blockers may provide the beams/TRPs which may be able to provide the coverage to the target device with its known location/position at the network node (e.g., gNB) in a case where (e.g., when) the serving beam may undergo failure. In this step, the UE/device may be switched and activated to a different panel which network node (e.g., gNB) may provide the indication as part of configuration. This indication may be in turn based upon the WTRU (e.g., UE) providing the implementation and capabilities of its antenna panels, transceivers, switching delays and detailed feature set as part of its assistance information.

In a compatible embodiment, the configuration may comprise multiple configurations. In one embodiment, two sub-configurations may be provided where one sub-configuration may be geared to translational mobility and the other sub-configuration may be geared towards rotational mobility and external mobility (including the blockage events in the network). This may be useful in the sense that a rotation of the device itself, or the blocking of a beam due to mobility in the network may require the device to choose a beam having the coverage to the same position but with a different orientation.

In a compatible approach, the network may provide a set of beam recovery configurations to a WTRU (e.g., UE). The network may provide the association of these configurations to different applications, different QoS for example different reliability requirements, different power consumption targets at WTRU (e.g., UE), WTRU (e.g., UE) active service subscription level etc. In a case where (e.g., when) a beam failure event occurs, a WTRU (e.g., UE) may choose the suitable beam recovery configuration according to the current situation as per the configured criterion. As described earlier, the multiple configurations can be associated to different physical parameters (like external or device mobility), different service reliability targets (one configuration while higher reliability may be used (e.g., required) and one configuration for lower reliability), different subscription levels (one configuration in a case where (e.g., when) the WTRU (e.g., UE) may be using paid content vs one configuration for the non-paid-content) etc.

In the event of mobility resulting in a compromised quality of the serving beam(s) according to the configured beam quality threshold, a WTRU (e.g., UE) may extract the information from its local sensors (S904). The sensors information can be combined with radio measurements over existing or newly designed reference signals received from the network. One example may be to combine the local sensors data with measurements performed using downlink positioning reference signals.

The WTRU (e.g., UE) may use this information to decide whether the link failure may be happening due to device mobility or external mobility (S905) and/or to select the correct set of candidate beams from the device mobility (S907) or external mobility (S906) configuration.

The WTRU (e.g., UE) may provide the information from local sensors to the suitable format of location/zone/orientation as per the configuration and may derive its location/orientation. With this location/orientation, The WTRU (e.g., UE) may determine the suitable beam (from the suitable TRP) from the configured mapping (S908-S909).

The entries in the mapping table may provide multiple candidate beams for a given location/orientation. In this case, the network node (e.g., gNB) may provide priority order for the candidate beams, and priority order for the TRPs. For example, prioritization (e.g., biasing) over beams or/and TRPs may be performed by the network to optimize its load balancing, energy savings, or/and deployment scenarios, etc. A WTRU (e.g., UE) may perform the beam recovery procedure on this determined beam using the configured set of recovery parameters. The beam recovery may be typically transmitting contention free RACH with configured parameters, e.g., indicating RACH sequence number, RACH occasion, timing and power ramping.

The WTRU (e.g., UE) may validate the selected TRP/beam combination according to the configured parameter settings (S910). The quality validation can be configured in terms of RSRP, RSRQ or SINR using suitable indicated measurement object from the selected TRP/beam. If the selected configuration satisfies the quality criterion, the WTRU (e.g., UE) may select the RACH configuration associated to the selected TRP/beam (S911) and may transmit RACH on the derived resource (S912).

In a compatible embodiment to enable proactive beam failure recovery, the configuration for candidate beams can be provided as a unified configuration. In this unified configuration, (e.g., all) the candidate beams and their priorities may be provided with their mapping to suitable geographic coordinates, orientations, and association with other parameters a WTRU (e.g., UE) can extract and use to determine the suitable beam. This unified configuration may harmonize the design which may provide the candidates that a WTRU (e.g., UE) can use in case of beam failure, independent of the reason (e.g., external mobility or device mobility) causing the beam failure.

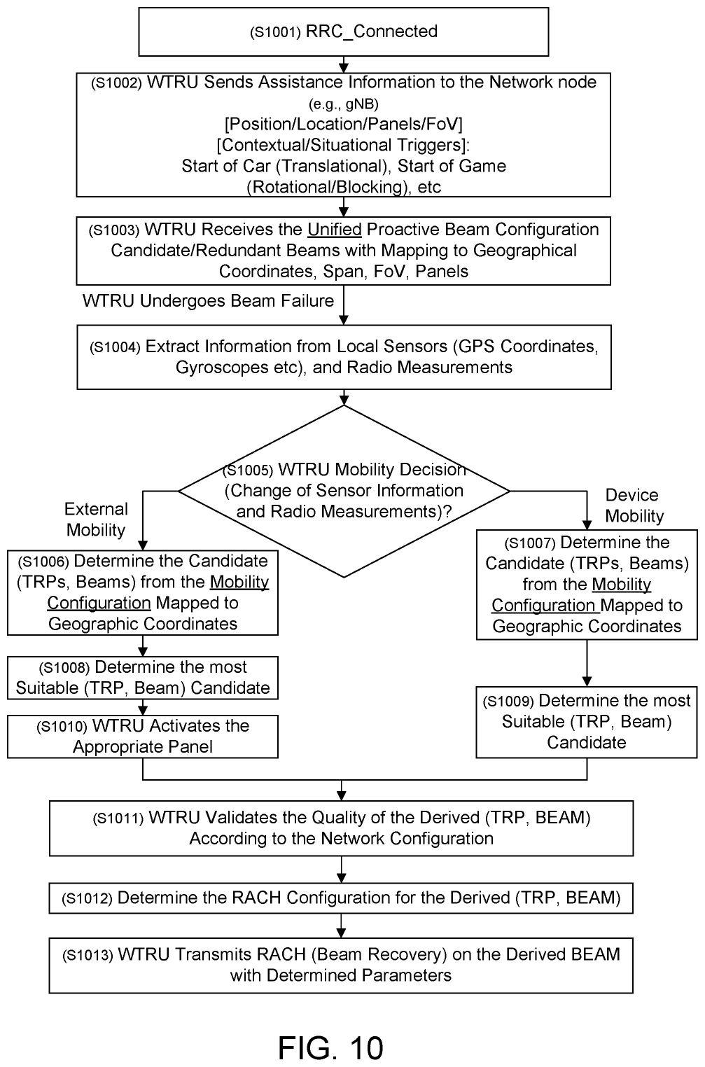

FIG. 10 shows a flowchart for proactive beam failure recovery with unified global configuration.

For a WTRU (e.g., UE) in a connected (e.g., RRC_CONNECTED) state (S1001), it may send the advanced assistance information to the network/network node (e.g., gNB) (S1002). This information from the WTRU (e.g., UE) may include the measurement-based information and non-measurement-based information. The parameters and elements for both broad categories within assistance information were detailed earlier. The assistance information may carry the information from the WTRU (e.g., UE) situation/context and the applications running which may require uncompromised mobility.

A (e.g., key) change here compared to the FIG. 9 may be that the network configuration for beam/TRP candidates may be provided in a unified manner, encompassing the candidates targeting external mobility and device mobility (S1003).

In the event of mobility resulting in a compromised quality of the serving beam(s) according to the configured beam quality threshold, a WTRU (e.g., UE) may extract the information from its local sensors (S1004). The sensors information can be combined with radio measurements over existing or newly designed reference signals received from the network. One example may be to combine the local sensors data with measurements performed using downlink positioning reference signals.

Once the device may be undergoing beam failure, the WTRU (e.g., UE) may get the information from its local sensors to decide whether the link failure may be happening due to device mobility or external mobility (S1005).

Based on this information combined with the information extracted from other interfaces and other sensor, the WTRU (e.g., UE) may pick/select the most suitable configuration for beam failure recovery, for example based on its geographic coordinates, to select the correct set of candidate beams from the device mobility (S1007) or external mobility (S1006) configuration.

The most suitable configuration can be directly derived from the network configured priority of any (e.g., each) candidate beam, for example, for the WTRU's (e.g., UE's) geographic coordinate. The WTRU (e.g., UE) may pick/select this configuration (S1008-S1009), and it may (e.g., need to) activate a different antenna panel as per the selected configuration (S1010). The flowchart shows the suitable panel activation (e.g., only) for external mobility case where (e.g., certainly) it may be more relevant, though the activation of suitable panel may also be used (e.g., needed) for device mobility case. In one example, the network may configure a priority order for the WTRU's (e.g., UE's) antenna panels based on the WTRU (e.g., UEL) assisting information on supported antenna panels sent to the network. The WTRU (e.g., UE) may select an antenna panel as per the configured priority order.

With a suitable antenna panel activated (e.g., with highest priority), the WTRU (e.g., UE) may validate the selected TRP/beam combination according to the configured parameter settings (S1011). The quality validation can be configured in terms of RSRP, RSRQ or SINR using suitable indicated measurement object from the selected TRP/beam.

If the selected configuration satisfies the quality criterion, the WTRU (e.g., UE) may select\determine the RACH configuration associated to the selected TRP/beam and may transmit RACH on the derived resource (S1012) and may transmit RACH on the derived resource (S1013). Although not shown in the flowchart for keeping the design clear to follow, if the selected TRP/beam does not satisfy the configured quality criterion, a WTRU (e.g., UE) may choose the next higher priority beam from the provided configuration until it finds the highest priority beam satisfying the quality criterion. In case of prioritization over the panels, if the WTRU (e.g., UE) does not find any suitable beams satisfying the quality criterion using the first selected panel, the WTRU (e.g., UE) may select the next higher priority panel from the provided configuration and find a suitable beam as per the given priority order for the beams. To speed up the process, a WTRU (e.g., UE) can take the multiple candidates indicated for the current geographic coordinates and may decide the highest priority candidate satisfying the quality criterion to trigger the recovery process on this candidate. If no configured candidate satisfies the quality criterion, a WTRU (e.g., UE) may resort to legacy beam recovery procedure.

### Design of Proposed Proactive Beam Recovery Configuration

This embodiment may propose the indication of coverage ensemble from the network with suitable beam level granularity. This may provide a WTRU (e.g., UE) with the knowledge of different cells/beams serving neighboring zones. In a case where (e.g., when) a WTRU (e.g., UE) moves from a zone served by one beam to another zone served by another beam, the location/orientation information from local sensors may lead a WTRU (e.g., UE) to determine the target beam serving the zone of its latest position. The WTRU (e.g., UE) may extract the beam recovery configuration corresponding to the determined beam and may perform beam failure recovery procedure.

In the following, two additional example configurations may be proposed for proactive beam recovery which may provide alternatives to the use of deployment/coverage ensemble. In these embodiments, the coverage relevant information for a beam may be provided as part of beam recovery configuration for any (e.g., each) candidate beam. The first embodiment proposes a standalone embodiment for Proactive BFR. The second embodiment proposes a joint embodiment for legacy and Proactive BFR. To make the exposition simple, a limited set of mapping parameters for candidate beams (rotational/orientation aspects) may be shown in these embodiments. Additional parameters for the candidate beams in terms of geographic coordinates, orientation, other subset of assistance information, and priorities can be indicated in the same manner.

### Standalone Design for Proactive BFR

An embodiment may be proposed where proactive BFR information element (IE) may be defined as an individual configuration element. Proactive beam failure recovery configuration IE may be introduced as part of configuration with new structures which may associate any (e.g., each) SSB/CSI-RS resource to a reference position/location and angular span.

Any (e.g., each) candidate beam whether based upon SSB or CSI-RS can be indicated with respect to a suitable reference against which its span may be indicated. New structures/templates may be introduced where for any (e.g., each) candidate beam, it may provide the reference position/location for a WTRU (e.g., UE) and its angular span.

| ProactiveBeamFailureRecoveryConfig ::= | SEQUENCE { | |
|---|---|---|
| rootSequenceIndex-BFR | INTEGER (0..137) | OPTIONAL, -- Need |

M

| rach-ConfigBFR | RACH-ConfigGeneric | OPTIONAL, -- Need M |
|---|---|---|
| rsrp-ThresholdSSB | RSRP-Range | OPTIONAL, -- Need M |
| ProactivecandidateBeamRSList | SEQUENCE (SIZE(1..maxNrofProactiveCandidateBeams)) OF | |
| ProactivePRACH-ResourceDedicatedBFR | OPTIONAL, -- Need M | |
| ssb-perRACH-Occasion | ENUMERATED {oneEighth, oneFourth, oneHalf, one, two, | |
| | four, eight, sixteen} | OPTIONAL, -- Need M |
| ra-ssb-OccasionMaskIndex | INTEGER (0..15) | OPTIONAL, -- Need |

M

| | | |
|---|---|---|
| recoverySearchSpaceId | SearchSpaceId | OPTIONAL, -- Need R |
| ra-Prioritization | RA-Prioritization | OPTIONAL, -- Need R |

| | |
|---|---|
| beamFailureRecoveryTimer | ENUMERATED {ms10, ms20, ms40, ms60, ms80, ms100, ms150, |
| ms200} | OPTIONAL, -- Need M |

```
  ...,
  [[
```

| | | |
|---|---|---|
| msg1-SubcarrierSpacing | SubcarrierSpacing | OPTIONAL -- Need |

```
M
  ]],
  [[
```

| | | |
|---|---|---|
| ra-PrioritizationTwoStep-r16 | RA-Prioritization | OPTIONAL, -- Need R |

| | |
|---|---|
| candidateBeamRSListExt-v1610 | SetupRelease{ CandidateBeamRSListExt-r16 } |

```
OPTIONAL -- Need M
  ]],
  [[
```

| | | |
|---|---|---|
| spCell-BFR-CBRA-r16 | ENUMERATED {true} | OPTIONAL -- Need |

R
]]
}

| | |
|---|---|
| ProactivePRACH-ResourceDedicatedBFR ::= | CHOICE { |
| ssb | Proactive-BFR-SSB-Resource, |
| csi-RS | Proactive-BFR-CSIRS-Resource |

}

| | |
|---|---|
| Proactive-BFR-SSB-Resource ::= | SEQUENCE { |
| ssb | SSB-Index, |
| active-area | Proactive-BFR-Mapping, |
| priority | INTEGER (range from Lowest Priority to Highest Priority) |
| ra-PreambleIndex | INTEGER (0..63), |

...
}

| Proactive-BFR-CSIRS-Resource ::= | SEQUENCE { | |
|---|---|---|
| csi-RS | NZP-CSI-RS-ResourceId, | |
| active-area | Proactive-BFR-Mapping, | |
| priority | INTEGER (range from Lowest Priority to Highest Priority) | |
| ra-OccasionList | SEQUENCE (SIZE(1..maxRA-OccasionsPerCSIRS)) OF INTEGER (0..maxRA- | |
| Occasions-1) | OPTIONAL, -- Need R | |
| ra-PreambleIndex | INTEGER (0..63) | OPTIONAL, -- Need |

R
...
}

| | |
|---|---|
| Proactive-BFR-Mapping ::= | SEQUENCE { |
| beam-reference-orientation | Reference-Orientation [in suitable coordinates] |
| beam-start-angle | BEAM-Start-Angle |
| beam-end-angle | BEAM-End-Angle |

...
}

In this embodiment any (e.g., each) candidate beam may have its indication of active area which may be a structure of type Proactive-BFR-Mapping. This can be defined with suitable parameter sets from measurement based information elements or non-measurement based information elements.

A compatible embodiment for providing the beam mapping can be the one where any (e.g., each) beam may be defined to have a reference angle. An example can be the center of the beam. For any (e.g., each) candidate beam, its orientation may be specified with respect to the reference beam/angle, and its beam width may be provided.

| | |
|---|---|
| Proactive-BFR-Mapping ::= | SEQUENCE { |
| beam-reference-orientation | Reference-Orientation [in suitable coordinates] |
| beam-orientation | Orientation-wrt-Reference-Orientation [in suitable coordinates] |
| beam-width | BEAM-WIDTH [in suitable coordinates] |

...
}

The configuration can be further updated if (e.g., all) SSB beams are to have a common beam width and/or (e.g., all) CSI-RS beams are to have a common beam width.

The beam angles whether defined as start and end angles with respect to a reference or a reference beam orientation angle defined with respect to a reference can be defined as the azimuth angle and vertical angle with respect to a reference direction, wherein the reference direction can be defined:
In the global coordinate system (GCS), wherein estimated azimuth angle may be measured relative to geographical North and may be positive in a counter-clockwise direction and estimated vertical angle may be measured relative to zenith and positive to horizontal direction.
In the local coordinate system (LCS), wherein estimated azimuth angle may be measured relative to x-axis of LCS and positive in a counter-clockwise direction and estimated vertical angle may be measured relative to z-axis of LCS and positive to x-y plane direction.

Despite standalone configuration of the Proactive BFR procedure, it may still run in parallel with legacy BFR procedure. A WTRU (e.g., UE) may receive configuration of a set of candidate beams with suitable mapping for Proactive BFR, and at the same time may receive a set of candidate beams for legacy BFR procedure.

### Unified Design for Proactive and Legacy BFR

According to embodiments, a unified configuration setup may be proposed which englobes proactive BFR and legacy BFR. In a case where (e.g., when) a network decides to configure a WTRU (e.g., UE) with BFR candidates, the configuration embodiment may be unique which can be used to provide a set of candidate beams for the legacy BFR and a set of candidate beams for the proposed Proactive BFR. The two sets may have overlapping candidate beams.

### BeamFailureRecoveryConfig

The IE BeamFailureRecoveryConfig may be used to configure the WTRU (e.g., UE) with RACH resources and candidate beams for beam failure recovery in case of beam failure detection. See also TS 38.321, clause 5.1.1.

-- ASN1START
-- TAG-BEAMFAILURERECOVERYCONFIG-START

| BeamFailureRecoveryConfig ::= | SEQUENCE { | |
|---|---|---|
| rootSequenceIndex-BFR | INTEGER (0..137) | OPTIONAL, -- Need |

M

| rach-ConfigBFR | RACH-ConfigGeneric | OPTIONAL, -- Need M |
|---|---|---|
| rsrp-ThresholdSSB | RSRP-Range | OPTIONAL, -- Need M |
| candidateBeamRSList | SEQUENCE (SIZE(1..maxNrofCandidateBeams)) OF PRACH- | |
| ResourceDedicatedBFR | OPTIONAL, -- Need M | |
| ProactivecandidateBeamRSList | SEQUENCE (SIZE(1..maxNrofProactiveCandidateBeams)) OF | |
| ProactivePRACH-ResourceDedicatedBFR | OPTIONAL, -- Need M | |
| ssb-perRACH-Occasion | ENUMERATED {oneEighth, oneFourth, oneHalf, one, two, | |
| | four, eight, sixteen} | OPTIONAL, -- Need M |
| ra-ssb-OccasionMaskIndex | INTEGER (0..15) | OPTIONAL, -- Need |

M

| | | |
|---|---|---|
| recoverySearchSpaceId | SearchSpaceId | OPTIONAL, -- Need R |
| ra-Prioritization | RA-Prioritization | OPTIONAL, -- Need R |

| | |
|---|---|
| beamFailureRecoveryTimer | ENUMERATED {ms10, ms20, ms40, ms60, ms80, ms100, ms150, |
| ms200} | OPTIONAL, -- Need M |

```
    ...,
    [[
```

| | | |
|---|---|---|
| msg1-SubcarrierSpacing | SubcarrierSpacing | OPTIONAL -- Need |

```
M
    ]],
    [[
```

| | | |
|---|---|---|
| ra-PrioritizationTwoStep-r16 | RA-Prioritization | OPTIONAL, -- Need R |
| candidateBeamRSListExt-v1610 | SetupRelease{ | } |
| | CandidateBeamRSListExt-r16 | |

```
OPTIONAL -- Need M
    ]],
    [[
```

| | | |
|---|---|---|
| spCell-BFR-CBRA-r16 | ENUMERATED {true} | OPTIONAL -- Need |

R
]]
}

| | |
|---|---|
| PRACH-ResourceDedicatedBFR ::= | CHOICE { |
| ssb | BFR-SSB-Resource, |
| csi-RS | BFR-CSIRS-Resource |

}

| | |
|---|---|
| BFR-SSB-Resource ::= | SEQUENCE { |
| ssb | SSB-Index, |
| ra-PreambleIndex | INTEGER (0..63), |

...
}

| BFR-CSIRS-Resource ::= | SEQUENCE { | |
|---|---|---|
| csi-RS | NZP-CSI-RS-ResourceId, | |
| ra-OccasionList | SEQUENCE (SIZE(1..maxRA-OccasionsPerCSIRS)) OF INTEGER (0..maxRA- | |
| Occasions-1) | OPTIONAL, -- Need R | |
| ra-PreambleIndex | INTEGER (0..63) | OPTIONAL, -- Need |

R
...
}

| | |
|---|---|
| Proactive-PRACH-ResourceDedicatedBFR ::= | CHOICE { |
| reference-orientation | Reference-Orientation, |
| ssb | Proactive-BFR-SSB-Resource, |
| csi-RS | Proactive-BFR-CSIRS-Resource |

}

| | |
|---|---|
| Proactive-BFR-SSB-Resource ::= | SEQUENCE { |
| ssb | SSB-Index, |
| ssb-start-angle | SSB-Start-Angle |
| ssb-end-angle | SSB-End-Angle |
| priority | INTEGER (range from Lowest Priority to Highest Priority) |
| ra-PreambleIndex | INTEGER (0..63), |

...
}

| Proactive-BFR-CSIRS-Resource ::= | SEQUENCE { | |
|---|---|---|
| csi-RS | NZP-CSI-RS-ResourceId, | |
| csi-RS-start-angle | CSI-RS-Start-Angle | |
| csi-RS-end-angle | CSI-RS-End-Angle | |
| priority | INTEGER (range from Lowest Priority to Highest Priority) | |
| ra-OccasionList | SEQUENCE (SIZE(1..maxRA-OccasionsPerCSIRS)) OF INTEGER (0..maxRA- | |
| Occasions-1) | OPTIONAL, -- Need R | |
| ra-PreambleIndex | INTEGER (0..63) | OPTIONAL, -- Need |

R
...
}

| | |
|---|---|
| CandidateBeamRSListExt-r16 ::= | SEQUENCE (SIZE(1..maxNrofCandidateBeamsExt-r16)) OF PRACH- |

ResourceDedicatedBFR
-- TAG-BEAMFAILURERECOVERYCONFIG-STOP
-- ASN1STOP

According to embodiments, a single reference orientation may be provided for (e.g., all) beams (e.g., contrary to the previous embodiment where any (e.g., each) candidate beam may be configured with its own reference orientation). A similar technique can be applied in this unified embodiment to have a beam based reference specified.

Individual proactive BFR and unified BFR configuration both may be defined for beams which may be derived based upon SSB or CSI-RS signals. The conditions for these measurement objects using SSB or CSI-RS can be defined using specific metrics e.g., RSRP, RSRQ and/or SINR etc. For ultra-massive MIMO, there may potentially be new reference symbol structures more suitable to resulting thousands of beams. These beams and relevant reference symbols may be transmitted in a hierarchical manner from the network. There may be multiple layers of such varying width beams. These ultra-massive and holographic MIMO beams may be suitably associated to potentially newly designed suitable reference symbols to provide Proactive BFR configurations to a WTRU (e.g., UE). These new reference symbols may follow the design and manner of transmission of such holographic beams. New measurement metrics may be designed which capture the quality of a given beam in a more accurate and fast manner. For the hierarchical design, the quality of a beam may be derived based upon measurement over potentially overlapping/overlaid beams. The beam failure and recovery conditions and thresholds can be suitably defined and configured using the existing reference symbols or the new reference symbols defined for emerging networks having large number of beams, using existing or new metrics and suitable thresholds to be evaluated in view of those reference symbols and measurement quantities.

### Beam Failure Recovery Configuration for Translational Motion

The embodiment proposed for proactive BFR by network sharing a configuring a WTRU (e.g., UE) with a limited snapshot of neighboring beams may be not limited to scenarios where WTRUs (e.g., UEs)/devices may be undergoing rotational movements. The proposal may be fully applicable to rotational movements, translational movements, mobile blockers blocking a certain beam/link or beam/link failures due to other reasons, or any combination of the former mobility/blocking events.

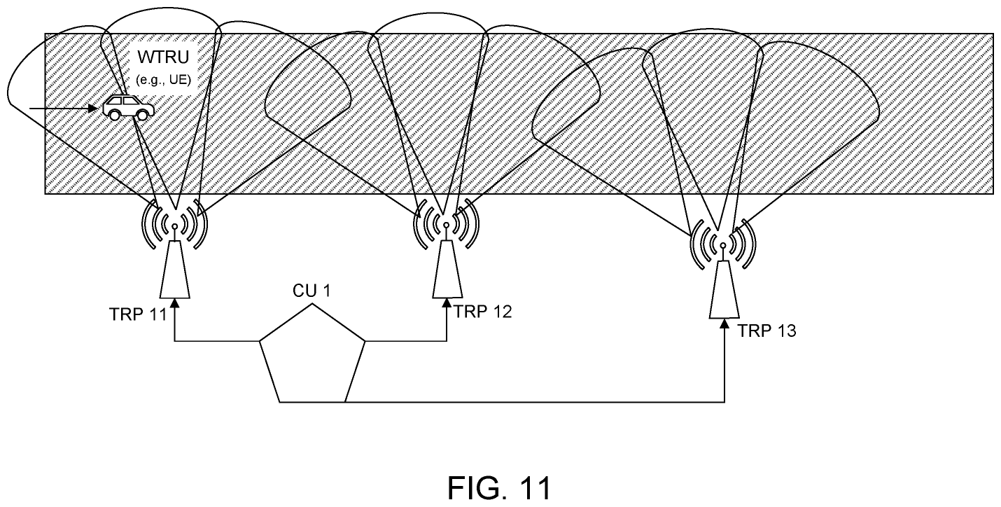

FIG. 11 shows a WTRU (e.g., UE) device inside a vehicle travelling on the road. This figure shows 3 TRPs each providing 3 beams to cover a part of the road stretch. The network can provide the beams configuration to the WTRU (e.g., UE) despite the WTRU (e.g., UE) not being able to discover beams that it has not been in the coverage yet. To cover the translation movement, the beam recovery configuration can include the beam identities tied to location they may be serving. This information can be communicated to a WTRU (e.g., UE) using its position and relative distance, or in terms of absolute positions for these beams which can be in terms of a suitable reference position and the beamwidth or cone of operation for any (e.g., each) beam.

SSB and CSI-RS beams may be indicated the active area individually where a reference direction can be indicated against which angular span may be specified. In addition to the angular span, the translational coverage area may be also specified using suitable coordinates. These coordinates can be the longitude and latitude for example as obtained through a GPS system. Suitable quantization can be applied to the indicated values to avoid the excessive overhead.

| | |
|---|---|
| ProactivePRACH-Resource DedicatedBFR ::= | CHOICE { |
| ssb | Proactive-BFR-SSB-Resource, |
| csi-RS | Proactive-BFR-CSIRS-Resource |

}

| | |
|---|---|
| Proactive-BFR-SSB-Resource ::= | SEQUENCE { |
| ssb | SSB-Index, |
| active-area | Proactive-BFR-Mapping, |
| priority | INTEGER (range from Lowest Priority to Highest Priority) |
| ra-PreambleIndex | INTEGER (0..63), |

...
}

| Proactive-BFR-CSIRS-Resource ::= | SEQUENCE { | |
|---|---|---|
| csi-RS | NZP-CSI-RS-ResourceId, | |
| active-area | Proactive-BFR-Mapping, | |
| priority | INTEGER (range from Lowest Priority to Highest Priority) | |
| ra-OccasionList | SEQUENCE (SIZE(1..maxRA-OccasionsPerCSIRS)) OF INTEGER (0..maxRA- | |
| Occasions-1) | OPTIONAL, -- Need R | |
| ra-PreambleIndex | INTEGER (0..63) | OPTIONAL, -- Need |

R
...
}

| | |
|---|---|
| Proactive-BFR-Mapping ::= | SEQUENCE { |
| beam-reference-orientation | Reference-Orientation [in suitable coordinates] |
| beam-start-angle | BEAM-Start-Angle |
| beam-end-angle | BEAM-End-Angle |
| beam-reference-position | Reference-Position [in suitable coordinates or Zones] |
| beam-Active-SPAN | Active-Span [in suitable geogrphaic coordinates or Zones] |

...
}

In Proactive-BFR-Mapping parameter struct, any (e.g., each) candidate beam (e.g., additionally) may have a reference-position and active-span indicated. This may enable mapping of a given beam to a certain geographic area with a certain angular span. This configuration may be suitably used in many of the real world situations that we encounter today as a combination of high mobility, large number of beams, and limited discovery/feedback opportunities. Further refinements to beam geographic coordinates and areas can be added in Proactive-BFR-Mapping structure to make it granular to the suitable extent and to have the coverage of the desired geographic spatial coordinates.

### Choice of Reference for Angular Span and Translational Active Area Indication

According to embodiments where the network node (e.g., gNB) may configure a WTRU (e.g., UE) with the candidate beams for beam recovery procedure, different suitable reference points can be used to indicate the angular span of a candidate beam and to indicate the active translational area.

To indicate the angular span of a candidate beam, the reference direction can be taken to be the serving beam of the network node (e.g., gNB). In another embodiment, the reference direction can be taken to be the one of the directions from the cardinal directions. The configuration of reference beam may be given in terms of TCI state containing the reference DL/UL beam or associated RS.

To indicate the active translational area for a candidate beam, this area can be indicated in terms of (e.g., absolute) GPS coordinates. According to embodiments, the active translational area can be specified with respect to a suitable reference location/position. This reference can be the position of the gNB, which can also be indicated as part of the configuration. The current position of the WTRU (e.g., UE) can be taken as a reference point. According to embodiments, in a case where (e.g., when) different beams may be originating from different TRPs, the network can configure the position of the source TRP along with the candidate beam. With this information, a WTRU (e.g., UE) may determine the strongest beam with the assumption of line of sight which can be quite reasonable for communication at high frequencies.

### Triggering Criteria for the Determination of a Suitable Candidate Beam and Current Serving Beam Replacement

A WTRU (e.g., UE) may monitor suitable measurement quantities on radio and non-radio measurements. Configured thresholds and events on these quantities may allow a WTRU (e.g., UE) determination of suitable candidate beam which should be used to replace the current serving beam and initiate the beam failure recovery.

According to embodiments, the network may provide the configuration of the coverage ensemble and/or the zone determination thresholds and/or events to trigger could be provided as part of beam recovery configuration.

According to embodiments, the zone determination thresholds may be part of the deployment/coverage ensemble configuration while the events over radio and non-radio measurements to trigger the beam recovery procedure over a candidate beam may be indicated as part of the beam recovery configuration.

According to embodiments, beam recovery configuration may comprise the (e.g., explicitly) defined execution conditions. Beam recovery configuration with suitable triggers and execution conditions may be provided to the WTRU (e.g., UE) by the network. The execution conditions point to the suitable measurement identities where the measurement configuration for the indicated measurement identities may provide the suitable events over radio and non-radio measurement quantities with (e.g., all) the (e.g., necessary) conditions and threshold for evaluation.

### Beam Failure Recovery for SpCell and SCell

Most of the steps of the proposed embodiment, relating to providing the WTRU (e.g., UE) assistance information, the network configuration of candidate beams, WTRU (e.g., UE) evaluation of the configured beams using the network provided geographic coordinates may stay valid for the beam failure recovery procedure triggered after beam failure detection for an SpCell or an SCell. As WTRU (e.g., UE) may not need to transmit RACH for BFR on an SCell, the proactive BFR configuration provided for an SCell may not include RACH preambles and relevant parameters. From WTRU (e.g., UE) action perspective, in a case where (e.g., once) a WTRU (e.g., UE) identifies the most suitable candidate beam for BFR, a WTRU (e.g., UE) may prepare a set of validated candidate beams and prepare a MAC CE, either BFR or truncated BFR.

For beam recovery procedure on an SpCell, a WTRU (e.g., UE) may transmit RACH according to the configured parameters and may transmit the MAC CE as part of the RACH transmission.

For beam recovery procedure on a SCell, a WTRU (e.g., UE) may transmit BFR or truncated BFR MAC CE to the network on the special cell which may be the primary cell of the relevant cell group. This procedure may get a significant latency benefit from WTRU (e.g., UE) being able to quickly determine the best beam thanks to the proposed embodiment where mapping of candidate beams may be provided with respect to the suitable geographic coordinates and can be made richer and more granular using the information from local sensors potentially combined with radio measurements. Proactive BFR configuration for SCell can be specified similar to section hereabove which may provide the configuration examples for SpCell. In a normal embodiment of BFR configuration for a SCell, RACH relevant details may be not provided. In the proposed approach, SCells may be configured for RACH transmission, and the BFR configuration for such SCells may comprise relevant RACH parameters.

To make BFR quicker for both SpCell and SCell, beam failure detection can be declared earlier or with larger thresholds compared to the legacy beam failure detection parameters in a case where (e.g., when) a WTRU (e.g., UE) may be configured with proactive beam failure recovery candidates. Two sets of thresholds can be indicated for beam failure detection. One may be the legacy beam failure detection threshold, and a new more stringent threshold which may be (e.g., only) applied in a case where (e.g., when) the WTRU (e.g., UE) has proactive configuration available. Beyond thresholds, new conditions or new events can be defined as more relevant for Proactive BFR.

### Exemplary Embodiments

Proactive BFR Procedure with Coverage Ensemble Indication as WTRU (e.g., UE) Dedicated Signaling

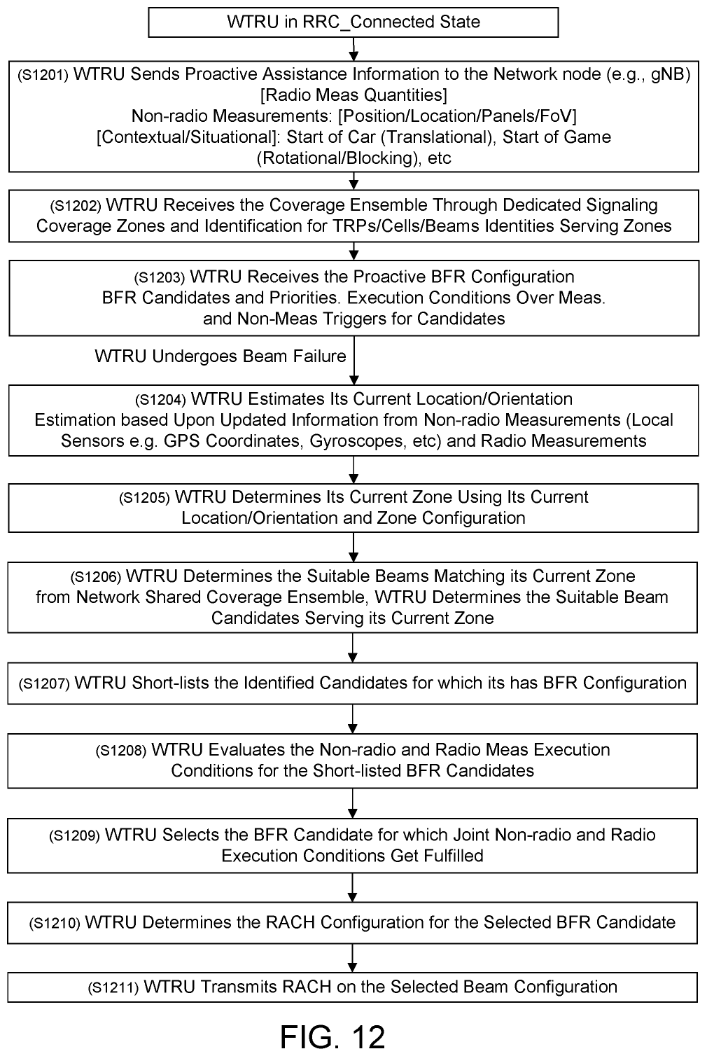

An exemplary embodiment specifying a procedure for a WTRU (e.g., UE) to have Proactive beam recovery while undergoing beam failure is shown in FIG. 12.

The method of proactive beam failure recovery may comprise any of the following steps:
(S1201) A WTRU (e.g., UE) sending the Assistance Information to the network node (e.g., gNB) comprising any of the following groups of information:
   Radio-measurement-quantity-based-data;
   Non-radio-measurement-quantity-based-data; and
   UE-capability-and-Implementation-details.
The network node (e.g., gNB) transmitting a beam-level coverage ensemble through WTRU (e.g., UE) dedicated signaling.
(S1202) A WTRU (e.g., UE) may receive the local beam-level coverage ensemble transmitted by the network comprising any of the following:
   Local snapshot of different zones at beam level granularity with identification of the coverage of different zones; and
   The beams associated to any (e.g., each) zone.
The network node (e.g., gNB) preparing a suitable Proactive BFR configuration based upon the received assistance information from a WTRU (e.g., UE) and the network deployment of its TRPs, cells and beam and transmitting this configuration to a WTRU (e.g., UE).
(S1203) A WTRU (e.g., UE) receiving a configuration from the network node (e.g., gNB) for the Proactive BFR comprising any of the following:
   A configuration comprising of different beam candidates to be used for beam failure recovery, comprising of the following parameters;
   Set of candidate beams;
   Candidate beams associated to suitable SSB, CSI-RS or newly designed reference signals;
   RACH parameters associated to any (e.g., each) candidate beam; and
   Measurement identities providing the events to trigger beam recovery combining the measurements on radio and non-radio quantities (e.g., these conditions and events can be specified in terms of events described earlier notably joint events J1, J2, J3, and J4 etc.).
In a case where (e.g., on a condition when) the WTRU (e.g., UE) detects Beam Failure (configured reference signals of the serving beam fall below a configured threshold or other conditions of BFD fulfilled), the WTRU (e.g., UE) may start the proactive beam failure recovery procedure.
(S1204) The WTRU (e.g., UE) may get the information from local sensors (GPS, Accelerometer, Gyroscope etc.) potentially combined with radio measurements and may determine the current values for its location/orientation parameters.
(S1205) The WTRU (e.g., UE) may determine its zone according to the network signaled coverage ensemble configuration using its geographic coordinates including at least its position, location and orientation etc.
(S1206) The WTRU (e.g., UE) may determine the beams associated to its determined zone from the network provided coverage ensemble.
(S1207) The WTRU (e.g., UE) short-lists the determined beam candidates for which it has received the proactive BFR configuration.
(S1208) The WTRU (e.g., UE) may measure and evaluate the radio and non-radio measurement quantities configured jointly as the execution condition(s) for the short-listed BFR candidate beams using the configured signal(s) and the configured threshold(s).
Beam failure recovery for an SpCell:
   (S1209) In a case where (e.g., on a condition when) the selected candidate passes the quality criterion over joint radio and non-radio quantities, the WTRU (e.g., UE) may extract its associated RACH configuration parameters (S1210).
   (S1211) The WTRU (e.g., UE) may transmit RACH for the BFR candidate using the derived RACH parameters. The WTRU (e.g., UE) may prepare and transmit BFR MAC-CE providing the information of the suitable candidate beam(s) to the network.
Beam Failure Recovery for on SCell:
   In a case where (e.g., on a condition when) the selected candidate passes the quality criterion over joint radio and non-radio quantities, the WTRU (e.g., UE) may prepare the BFR MAC-CE.
   The WTRU (e.g., UE) may transmit BFR MAC-CE to the network.

### The Above Exemplary Embodiment, Wherein

The WTRU (e.g., UE) may be configured with multiple sets of Proactive BFR configurations which may be associated to different parameters/situations.
The WTRU may be configured with two sets of Proactive BFR configurations which may be associated to Device Mobility and External Mobility, and the WTRU (e.g., UE) may determine the suitable configuration to use by determining the cause of mobility as device mobility or external mobility from the local sensors' measurements.
The sets of BFR configurations may be indicated to be associated to different QoS requirements of specific applications/services running at WTRU (e.g., UE) device.
The sets of BFR configurations may be indicated to be associated to different levels of WTRU (e.g., UE) power consumption requirements.
The sets of BFR configurations may be indicated to be associated to WTRU (e.g., UE) active subscription.
The set of BFR configurations may be associated to different levels of WTRU (e.g., UE) speed/velocity values.
The network provided ensemble may comprise the deployment parameters of its cells, TRPs and beam relevant parameters.
The WTRU (e.g., UE) may perform post-processing on the deployment ensemble received from the network to fabricate the effective coverage ensemble.
The WTRU (e.g., UE) post-processing on the deployment ensemble can use the information from its local sensors to fabricate the effective coverage ensemble.
The WTRU (e.g., UE) post-processing on the deployment ensemble can use the locally stored information to fabricate the effective coverage ensemble. One example can be to use the topographical and terrain related ensembles which can be available in the local storage or through some other source.
The Proactive BFR configuration may indicate to WTRU (e.g., UE) to activate a specific of its available antenna panels.
The WTRU (e.g., UE) may determine a suitable antenna panel for a given BFR candidate as a function of its location, orientation, and the coverage ensemble attributes.
The WTRU (e.g., UE) validating the execution conditions for a given BFR candidate through its relevant determined/indicated WTRU (e.g., UE) antenna panel.
The WTRU (e.g., UE) initiating the RACH procedure with the successful configuration/candidate using the determined/indicated antenna panel.
   Proactive BFR Procedure with Coverage Ensemble Indication as Broadcast Signaling

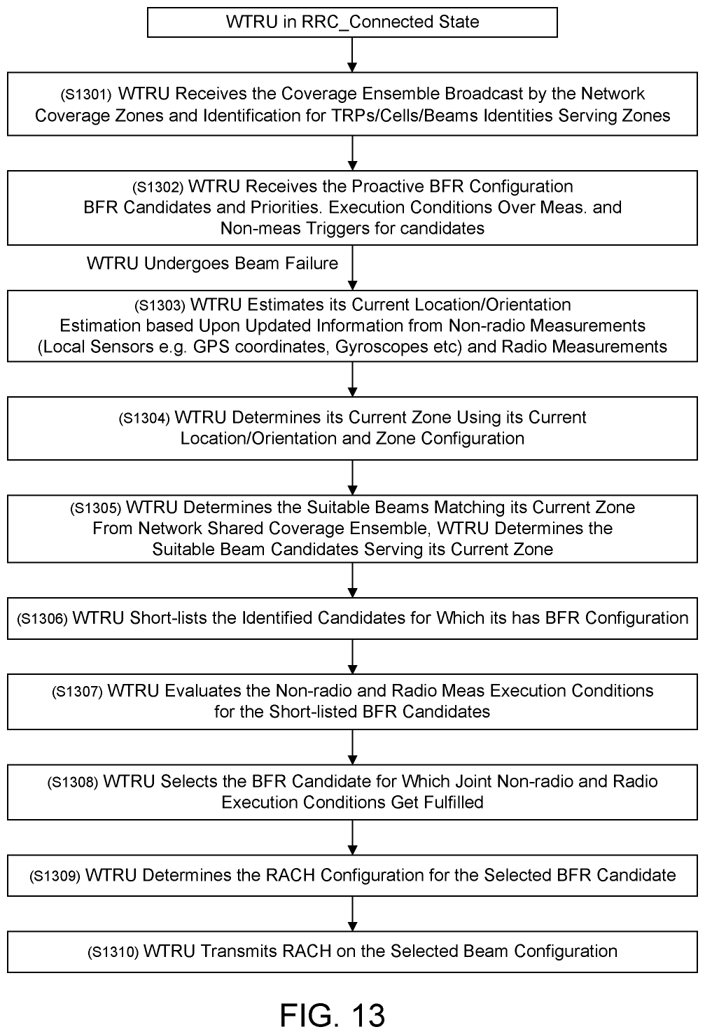

An exemplary embodiment specifying a procedure for a WTRU (e.g., UE) to have proactive beam recovery while undergoing beam failure is shown in FIG. 13.

The method of proactive beam failure recovery may comprise any of the following steps:
(S1301) A WTRU (e.g., UE) may receive the local beam-level coverage ensemble transmitted by the network as part of the system information broadcast comprising of the following:
   Local snapshot of different zones at beam level granularity with identification of the coverage of different zones.
   The beam associated to any (e.g., each) zone.
(S1302) A WTRU (e.g., UE) receiving a configuration from the network node (e.g., gNB) for the Proactive BFR comprising any of the following:
   A configuration comprising of different beam candidates to be used for beam failure recovery, comprising of the following parameters.
   Set of candidate beams.
   Candidate beams associated to suitable SSB, CSI-RS or newly designed reference signals.
   RACH parameters associated to any (e.g., each) candidate beam.
   Measurement identities providing the events to trigger beam recovery combining the measurements on radio and non-radio quantities.
In a case where (e.g., on a condition when) the WTRU (e.g., UE) detects Beam Failure (configured reference signals of the serving beam fall below a configured threshold or conditions of BFD fulfilled), the WTRU (e.g., UE) may start the proactive beam failure recovery procedure.
(S1303) The WTRU (e.g., UE) may get the information from local sensors (GPS, Accelerometer, Gyroscope, etc.) potentially combined with radio measurements and may determine the current values for its location/orientation parameters.
(S1304) The WTRU (e.g., UE) may determine its zone according to the network broadcast coverage ensemble using its geographic coordinates (position/location and orientation, etc.).
(S1305) The WTRU (e.g., UE) may determine the beams associated to its determined zone from the network broadcast coverage ensemble.
(S1306) The WTRU (e.g., UE) may short-list the determined beam candidates for which it has received the proactive BFR configuration.
(S1307) The WTRU (e.g., UE) may measure and evaluate the radio and non-radio measurement quantities configured jointly as the execution condition(s) for the short-listed BFR candidate beam using the configured signal(s) and the configured threshold(s).
Beam Failure Recovery for an SpCell:
   (S1308) In a case where (e.g., on a condition when) the selected candidate passes the quality criterion over joint radio and non-radio quantities, the WTRU (e.g., UE) may extract its associated RACH configuration parameters (S1309).
   (S1310) WTRU (e.g., UE) may transmit RACH for the BFR candidate using the derived RACH parameters. The WTRU (e.g., UE) may prepare and transmit BFR MAC-CE providing the information of the suitable candidate beam(s) to the network.
Beam Failure Recovery for on SCell:
   In a case where (e.g., on a condition when) the selected candidate passes the quality criterion over joint radio and non-radio quantities, the WTRU (e.g., UE) may prepare the BFR MAC-CE.
   The WTRU (e.g., UE) may transmit BFR MAC-CE to the network.

### The Above Exemplary Embodiment, Wherein

The WTRU (e.g., UE) may be configured with multiple sets of Proactive BFR configurations which may be associated with different parameters/situations.
The WTRU may be configured with at least two sets of Proactive BFR configurations which may be associated to device mobility and external mobility, and the WTRU (e.g., UE) may determine the suitable configuration to use by determining the cause of mobility as device mobility or external mobility from the local sensors' measurements.
The sets of BFR configurations may be indicated to be associated to different levels of QoS requirements of specific applications/services running at WTRU (e.g., UE) device.
The sets of BFR configurations may be indicated to be associated to different levels of WTRU (e.g., UE) power consumption requirements.
The sets of BFR configurations may be indicated to be associated to WTRU (e.g., UE) active subscription.
The set of BFR configurations may be associated to different values of the WTRU (e.g., UE) speed/velocity.
The network provided ensemble may comprise the deployment parameters of its cells, TRPs and/or beam relevant parameters.
The WTRU (e.g., UE) may perform post-processing on the deployment ensemble received from the network to fabricate the effective coverage ensemble.
The WTRU (e.g., UE) post-processing on the deployment ensemble can use the information from its local sensors to fabricate the effective coverage ensemble.
The WTRU (e.g., UE) post-processing on the deployment ensemble can use the locally stored information to fabricate the effective coverage ensemble. One example can be to use the topographical and terrain related ensembles which can be available in the local storage or through some other source.
The proactive BFR configuration may indicate to WTRU (e.g., UE) to activate a specific of its available antenna panels.
The WTRU (e.g., UE) may determine a suitable antenna panel for a given BFR candidate as a function of its location, orientation, and/or the coverage ensemble attributes.
The WTRU (e.g., UE) validating the execution conditions for a given BFR candidate through its relevant determined/indicated antenna panel.
The WTRU (e.g., UE) initiating the RACH procedure with the successful configuration/candidate using the determined/indicated antenna panel.
   Proactive BFR with a Single BFR Configuration Providing Geographic Coverage

An exemplary embodiment specifying a procedure for a WTRU (e.g., UE) to have Proactive beam failure recovery procedure comprising any of the following steps:
A WTRU (e.g., UE) sending the Assistance Information to the network node (e.g., gNB) comprising any of the following groups of information:
   Radio-measurement-quantity-based-data;
   Non-radio-measurement-quantity-based-data; and
   UE-capability-and-Implementation-details.
The network node (e.g., gNB) preparing a suitable Unified Proactive BFR configuration based upon the received assistance information from a WTRU (e.g., UE) and the network deployment of its TRPs, cells and beam and transmitting this configuration to a UE.
A WTRU (e.g., UE) receiving the configuration from the network node (e.g., gNB) for the Proactive BFR comprising any of the following:
   A single configuration covering device mobility and external mobility comprising of the following parameters;
   Set of candidate beams;
   Candidate beams associated to suitable SSB, CSI-RS or newly designed reference signals;
   RACH parameters associated to any (e.g., each) candidate beam;
   Mapping of candidate beams to suitable geographic coordinates (location, position, orientation) to accommodate Device Mobility and External Mobility; and
   Indication of priority for candidate beams in a case where (e.g., when) multiple candidate beams may have at least partial overlapping coverage.
In a case where (e.g., on a condition when) the WTRU (e.g., UE) detects Beam Failure (configured reference signals of the serving beam fall below a configured threshold or other conditions of BFD fulfilled), the WTRU (e.g., UE) may start the proactive beam failure recovery procedure.
The WTRU (e.g., UE) may get the information from local sensors (GPS, Accelerometer, Gyroscope, etc.) potentially combined with radio measurements.
The WTRU (e.g., UE) may evaluate the change in local sensors data and configured conditions to determine device mobility or external mobility as per the configuration to determine Device Mobility or External Mobility,
If Device Mobility is determined:
   The WTRU (e.g., UE) determining the candidate beams as recovery Candidate from the configured mapping table using its determined geographic coordinates (position/location and orientation, etc.) and radio measurements.
If External Mobility is determined:
   The WTRU (e.g., UE) determining the candidate beams as recovery Candidate from the configured mapping table using its determined geographic coordinates (position/location and orientation, etc.). This may include removing the beam over which beam failure detection occurs in case of external mobility.

The WTRU (e.g., UE) may select the highest priority beam among the determined candidates.
The WTRU (e.g., UE) may activate the antenna panel associated with the selected BFR candidate.
The WTRU (e.g., UE) may measure the quality of the selected BFR candidate beam using the configured measurement signal(s) and the configured threshold(s).
Beam Failure Recovery for an SpCell:
   In a case where (e.g., on a condition when) the selected candidate passes the quality criterion, the WTRU (e.g., UE) may extract its associated RACH configuration parameters.
   The WTRU (e.g., UE) may transmit RACH for the BFR candidate using the derived RACH parameters. The WTRU (e.g., UE) may prepare and transmit BFR MAC-CE providing the information of the suitable candidate beam(s) to the network.
Beam Failure Recovery for on SCell:
   In a case where (e.g., on a condition when) the selected candidate passes the quality criterion, the WTRU (e.g., UE) may prepare the BFR MAC-CE.
   The WTRU (e.g., UE) may transmit BFR MAC-CE to the network.
      Proactive BFR with Multiple BFR Configurations Providing Geographic Coverage

An exemplary embodiment specifying a procedure for a WTRU (e.g., UE) to have proactive while undergoing beam failure recovery procedure:
A WTRU (e.g., UE) sending the Assistance Information to the network node (e.g., gNB) comprising any of the following groups of information:
   Radio-measurement-quantity-based-data;
   Non-radio-measurement-quantity-based-data; and
   UE-capability-and-Implementation-details.
The network node (e.g., gNB) preparing multiple suitable proactive BFR configurations based upon the received assistance information from a WTRU (e.g., UE), the WTRU (e.g., UE) profile, and the network deployment of its TRPs, cells and beam and transmitting this configuration to a UE.
A WTRU (e.g., UE) receiving the configuration set from the network node (e.g., gNB) for the Proactive BFR comprising any of the following:
   Two configurations for device mobility and external mobility where any (e.g., each) configuration may comprise any the following parameters:
      Set of candidate beams/TRPs;
      Candidate beams associated to suitable SSB, CSI-RS or newly designed reference signals;
      RACH parameters associated to any (e.g., each) candidate beam;
      Mapping of candidate TRPs/beams to location/position, orientation for device mobility;
      Mapping of candidate TRPs/beams for external mobility; and
      Indication of priority for candidate beams in a case where (e.g., when) multiple candidate beams may have at least partial overlap for certain geographic coordinates.
In a case where (e.g., on a condition when) the WTRU (e.g., UE) detects Beam Failure (configured reference signals of the serving beam fall below a configured threshold or conditions of BFD fulfilled), the WTRU (e.g., UE) may start the beam failure recovery procedure.
The WTRU (e.g., UE) may get the information from local sensors (GPS, Accelerometer, Gyroscope etc.) potentially combined with radio measurements.
The WTRU (e.g., UE) may evaluate the change in local sensors data and configured conditions to determine device mobility or external mobility as per the configuration to determine device mobility or external mobility.
If the WTRU (e.g., UE) determines device mobility:
   The WTRU (e.g., UE) may select the device mobility BFR configuration.
   The WTRU (e.g., UE) determining the candidate beams as recovery candidate from the selected configuration mapping table using its determined geographic coordinates (position/location and orientation, etc.) and radio measurements.
If the WTRU (e.g., UE) determines external mobility:
   The WTRU (e.g., UE) may select the external mobility BFR configuration.
   The WTRU (e.g., UE) determining the candidate beams as recovery candidate from the selected configuration mapping table using its determined geographic coordinates (position/location and orientation, etc.). This may include removing the beam over which beam failure detection occurs in case of external mobility.
The WTRU (e.g., UE) may select the highest priority beam among the determined candidates.
The WTRU (e.g., UE) may activate the antenna panel associated with the selected BFR candidate.
The WTRU (e.g., UE) may measure the quality of the selected BFR candidate beam using the configured measurement signal(s) and the configured threshold(s).
Beam Failure Recovery for an SpCell:
   In a case where (e.g., on a condition when)) the selected candidate passes the quality criterion, the WTRU (e.g., UE) may extract its associated RACH configuration parameters.
   The WTRU (e.g., UE) may transmit RACH for the BFR candidate using the derived RACH parameters. The WTRU (e.g., UE) may prepare and transmit BFR MAC-CE providing the information of the suitable candidate beam(s) to the network.
Beam Failure Recovery for on SCell:
   In a case where (e.g., on a condition when) the selected candidate passes the quality criterion, the WTRU (e.g., UE) may prepare the BFR MAC-CE.
   The WTRU (e.g., UE) may transmit BFR MAC-CE to the network.

In one embodiment, a method implemented by the WTRU includes sending first information comprising data from local sensors and radio measurements. The method may further include receiving second information indicating a network deployment. The method may further include receiving third information indicating a configuration associated to a set of candidate beams. The method may further include selecting a subset of candidate beams from the set of candidate beams based on a current location and/or orientation of the WTRU, responsive to the detection of a beam failure. The method may further include selecting a candidate beam of the subset of candidate beams, wherein the candidate beam may meet configured radio and non-radio trigger conditions. The method may further include determining RACH parameters from the configuration received for the selected candidate beam. The method may further include sending RACH transmission on the selected candidate beam using the RACH parameters.

In certain representative embodiments, the data from local sensors may comprise any of: a position of the WTRU, a location of the WTRU.

In certain representative embodiments, the first information may further indicate any of: a field of view, an application Quality of Service.

In certain representative embodiments, the second information may be transmitted by a network node through a system information broadcast.

In certain representative embodiments, the second information may be transmitted by a network node through a dedicated signaling.

In certain representative embodiments, the method may further comprise determining the current location and/or orientation of the WTRU from the local sensors.

In certain representative embodiments, the method may further comprise determining the current location and/or orientation of the WTRU with radio measurements.

In certain representative embodiments, the network deployment may indicate any of: a local snapshot of different zones at beam level granularity with identification of a coverage of the different zones, and beams associated to any (e.g., each) zone.

### Example Implementation(s)

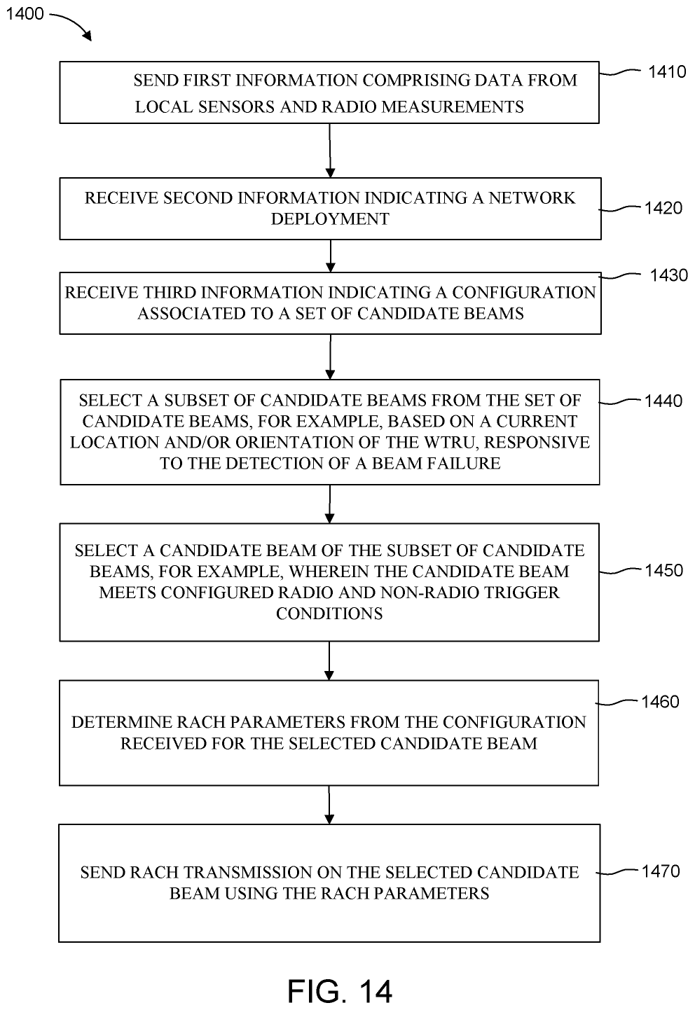

It is envisioned that the methods previously described herein may be combined in various ways. For example, referring to FIG. 14, a method of wireless communication 1400 implemented by a WTRU 102.

According to embodiments, the WTRU 102 may be configured to send first information comprising data from local sensors and radio measurements (S1410).

According to embodiments, the WTRU 102 may be configured to receive second information indicating a network deployment (S1420).

According to embodiments, the WTRU 102 may be configured to receive third information indicating a configuration associated to a set of candidate beams (51430).

According to embodiments, the WTRU 102 may be configured to select a subset of candidate beams from the set of candidate beams, for example, based on a current location and/or orientation of the WTRU, responsive to the detection of a beam failure (S1440)

According to embodiments, the WTRU 102 may be configured to select a candidate beam of the subset of candidate beams, for example, wherein the candidate beam meets configured radio and non-radio trigger conditions (S1450).

According to embodiments, the WTRU 102 may be configured to determine RACH parameters from the configuration received for the selected candidate beam (S1460).

According to embodiments, the WTRU 102 may be configured to send RACH transmission on the selected candidate beam using the RACH parameters (S1470).

According to embodiments, the data from local sensors may comprise any of: a position of the WTRU, a location of the WTRU.

According to embodiments, the first information may indicate any of: a field of view, an application Quality of Service.

According to embodiments, the second information may be transmitted by a network node through a system information broadcast.

According to embodiments, the second information may be transmitted by a network node through a dedicated signaling.

According to embodiments, the WTRU 102 may be configured to determine the current location and/or orientation of the WTRU from the local sensors.

According to embodiments, the WTRU 102 may be configured to determine the current location and/or orientation of the WTRU with radio measurements.

According to embodiments, the network deployment may indicate any of: a local snapshot of different zones at beam level granularity with identification of a coverage of the different zones, and beams associated to any (e.g., each) zone.

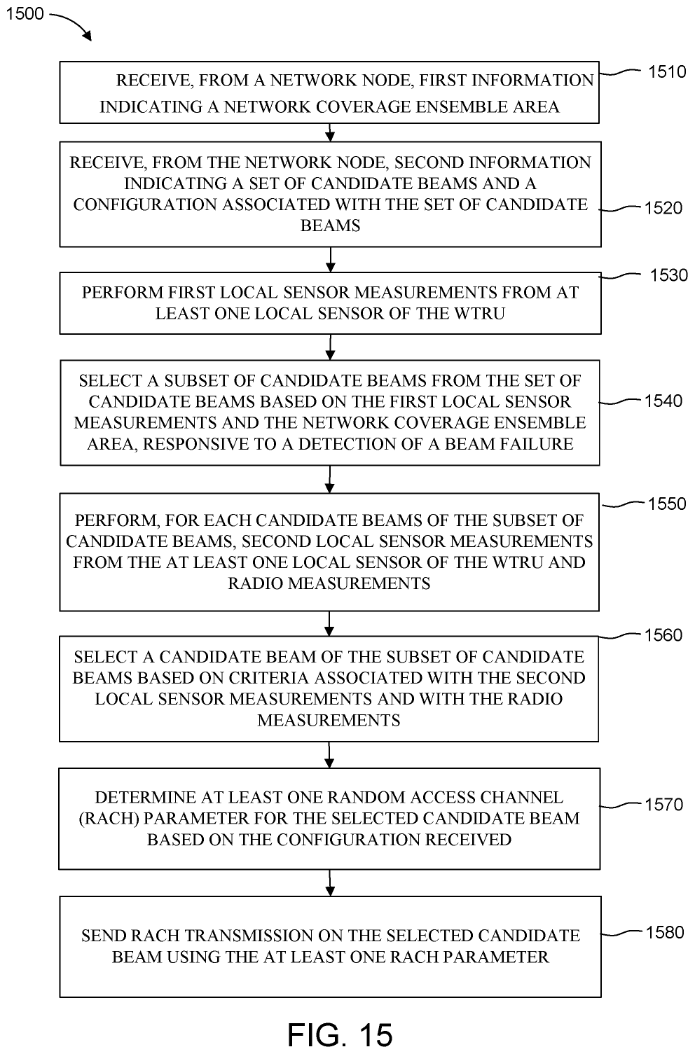

Referring to FIG. 15, a method of wireless communication 1500 implemented by a WTRU 102 is illustrated.

According to embodiments, the WTRU 102 may be configured to receive, from a network node, first information indicating a network coverage ensemble area (e.g., a plurality of network coverage zones) (S1510).

According to embodiments, the WTRU 102 may be configured to receive, from the network node, second information indicating a set of candidate beams and a configuration associated with the set of candidate beams (S1520).

According to embodiments, the WTRU 102 may be configured to perform first local sensor measurements from at least one local sensor of the WTRU (S1530).

According to embodiments, the WTRU 102 may be configured to select a subset of candidate beams from the set of candidate beams based on the first local sensor measurements and the network coverage ensemble area, responsive to a detection of a beam failure (S1540).

According to embodiments, the WTRU 102 may be configured to perform, for each candidate beams of the subset of candidate beams, second local sensor measurements from the at least one local sensor of the WTRU and radio measurements (S1550).

According to embodiments, the WTRU 102 may be configured to select a candidate beam of the subset of candidate beams based on criteria associated with the second local sensor measurements and with the radio measurements (S1560).

According to embodiments, the WTRU 102 may be configured to determine at least one random access channel (RACH) parameter for the selected candidate beam based on the configuration received (S1570).

According to embodiments, the WTRU 102 may be configured to send RACH transmission on the selected candidate beam using the at least one RACH parameter (S1580).

According to embodiments, the configuration indicates at least one RACH parameter associated with each candidate beam of the set of candidate beams.

According to embodiments, the configuration indicates at least one local sensor measurement threshold and at least one radio measurement threshold.

According to embodiments, the criteria are based on a comparison of the second local sensor measurements to the at least one local sensor measurement threshold and a comparison of the radio measurements to the at least one radio measurement threshold.

According to embodiments, the first information indicates a plurality of zones of coverage, and wherein each zone of the plurality of zones of coverage is associated with at least a beam of the set of candidate beams.

According to embodiments, select the subset of candidate beams comprises the WTRU being configured to: determine a current location and/or orientation of the WTRU based on the first local sensor measurements; and/or select a zone of coverage from the plurality of zones of coverage based on the current location and/or orientation of the WTRU, and wherein the zone of coverage is associated with the subset of candidate beams.

According to embodiments, determine a current location and/or orientation of the WTRU is based on second radio measurements.

According to embodiments, the second information is received from the network node through a system information broadcast and/or through a dedicated signaling.

According to embodiments, receive first information indicating a network coverage ensemble area comprises the WTRU being configured to: send, to the network node, third information comprising data from local sensors and further radio measurements, and wherein the network coverage ensemble area is based on the third information.

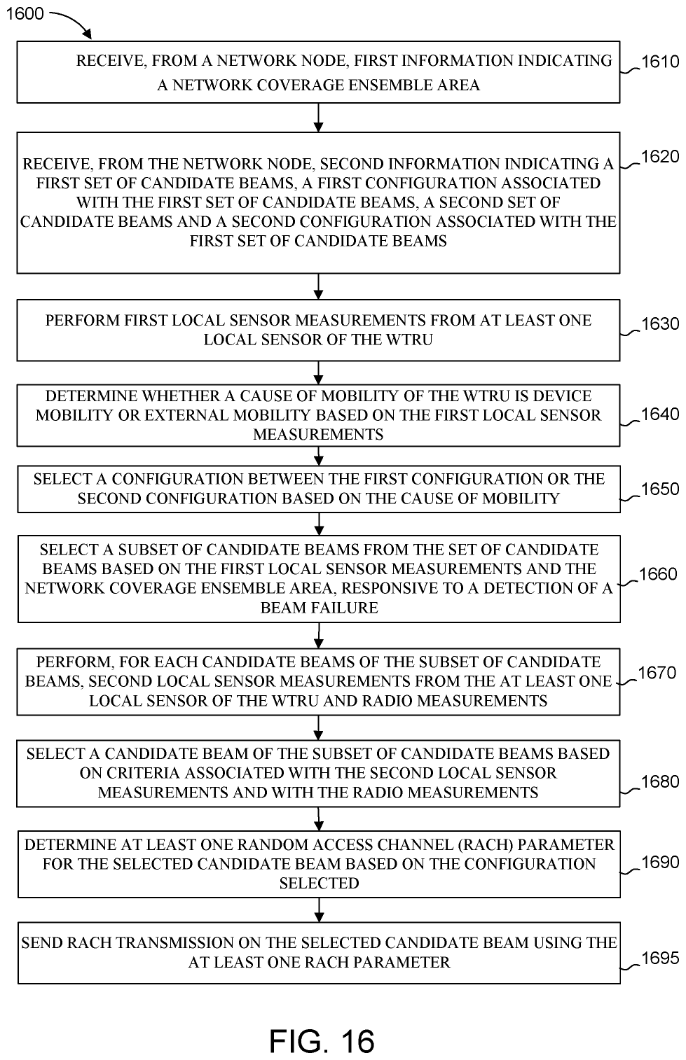

Referring to FIG. 16, a method of wireless communication 1600 implemented by a WTRU 102 is illustrated.

According to embodiments, the WTRU 102 may be configured to receive, from a network node, first information indicating a network coverage ensemble area (e.g., a plurality of network coverage zones) (S1610).

According to embodiments, the WTRU 102 may be configured to receive, from the network node, second information indicating a first set of candidate beams, a first configuration associated with the first set of candidate beams, a second set of candidate beams and a second configuration associated with the first set of candidate beams (S1620).

According to embodiments, the WTRU 102 may be configured to perform first local sensor measurements from at least one local sensor of the WTRU (S1630).

According to embodiments, the WTRU 102 may be configured to determine whether a cause of mobility of the WTRU is device mobility or external mobility based on the first local sensor measurements (S1640).

According to embodiments, the WTRU 102 may be configured to select a configuration between the first configuration or the second configuration based on the cause of mobility (S1650).

According to embodiments, the WTRU 102 may be configured to select a subset of candidate beams from the set of candidate beams based on the first local sensor measurements and the network coverage ensemble area, responsive to a detection of a beam failure (S1660);

According to embodiments, the WTRU 102 may be configured to perform, for each candidate beams of the subset of candidate beams, second local sensor measurements from the at least one local sensor of the WTRU and radio measurements (S1670).

According to embodiments, the WTRU 102 may be configured to select a candidate beam of the subset of candidate beams based on criteria associated with the second local sensor measurements and with the radio measurements (S1680).

According to embodiments, the WTRU 102 may be configured to determine at least one random access channel (RACH) parameter for the selected candidate beam based on the configuration selected (S1690).

According to embodiments, the WTRU 102 may be configured to send RACH transmission on the selected candidate beam using the at least one RACH parameter (S1695).

According to embodiments, the selected configuration indicates at least one RACH parameter associated with each candidate beam of the set of candidate beams.

According to embodiments, the selected configuration indicates at least one local sensor measurement threshold and at least one radio measurement threshold.

According to embodiments, the criteria are based on a comparison of the second local sensor measurements to the at least one local sensor measurement threshold and a comparison of the radio measurements to the at least one radio measurement threshold.

According to embodiments, the WTRU is configured to select a candidate beam of the subset of candidate beams based on a priority criteria; activate an antenna panel of the WTRU, wherein the antenna panel is associated with the selected candidate beam; measure a quality of the selected candidate beam, for example, using at least one configured measurement signal(s); and/or

perform the determination of the at least one RACH parameter and/or the transmission of the at least one RACH parameter based on a comparison of the measured quality with a quality threshold.

According to embodiments, the first information indicates a plurality of zones of coverage, and wherein each zone of the plurality of zones of coverage is associated with at least a beam of the set of candidate beams.

According to embodiments, select the subset of candidate beams comprises the WTRU being configured to: determine a current location and/or orientation of the WTRU based on the first local sensor measurements; and/or select a zone of coverage from the plurality of zones of coverage based on the current location and/or orientation of the WTRU, and wherein the zone of coverage is associated with the subset of candidate beams.

According to embodiments, determine a current location and/or orientation of the WTRU is based on second radio measurements.

According to embodiments, the second information is received from the network node through a system information broadcast and/or through a dedicated signaling.

According to embodiments, receive first information indicating a network coverage ensemble area comprises the WTRU being configured to: send, to the network node, third information comprising data from local sensors and further radio measurements, and wherein the network coverage ensemble area is based on the third information.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Δny listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-18. (canceled)

19. A method implemented by a wireless transmit/receive unit (WTRU) in a network comprising a network node, the method comprising:
receiving, from the network node, configuration information indicating a network coverage ensemble area, the configuration information indicating a plurality of zones of coverage of the network node and of neighboring network nodes and wherein each zone of the plurality of zones of coverage is associated with at least a beam of a set of candidate beams;
performing first local sensor measurements from at least one local sensor of the WTRU;
selecting a subset of candidate beams from the set of candidate beams based on the first local sensor measurements and the configuration information, responsive to a detection of a beam failure;
performing second local sensor measurements from at least one local sensor of the WTRU and radio measurements for candidate beams of the subset of candidate beams;
selecting a candidate beam from the subset of candidate beams, for which the second local sensor measurements and radio measurements meet at least one local sensor measurement threshold and at least one radio measurement threshold;
determining at least one random access channel (RACH) parameter for the selected candidate beam based on the configuration information received; and
sending a RACH transmission on the selected candidate beam using the at least one RACH parameter.

20. The method of claim 19, wherein the configuration information indicates at least one RACH parameter associated with each candidate beam of the set of candidate beams.

21. The method of claim 19, wherein selecting a candidate beam from the subset of candidate beams comprises comparing the second local sensor measurements to the at least one local sensor measurement threshold and comparing the radio measurements to the at least one radio measurement threshold.

22. The method of claim 19, wherein selecting the subset of candidate beams comprises:
determining a current location and/or orientation of the WTRU based on the first local sensor measurements; and
selecting a zone of coverage from the plurality of zones of coverage based on the current location and/or orientation of the WTRU, and wherein the zone of coverage is associated with the subset of candidate beams.

23. The method of claim 22, wherein determining a current location and/or orientation of the WTRU is based on second radio measurements.

24. The method of claim 19, wherein the configuration information is received from the network node through a system information broadcast and/or through a dedicated signaling.

25. The method of claim 19, wherein receiving configuration information indicating a network coverage ensemble area comprises:
sending, to the network node, information comprising data from local sensors and further radio measurements, and wherein the network coverage ensemble area is based on the information.

26. A wireless transmit/receive unit (WTRU) in a network comprising a network node, the WTRU comprising a processor, a transmitter, a receiver, and memory, the WTRU configured to:
receive, from the network node, configuration information indicating a network coverage ensemble area, the configuration information indicating a plurality of zones of coverage of the network node and of neighboring network nodes and wherein each zone of the plurality of zones of coverage is associated with at least a beam of a set of candidate beams;
perform first local sensor measurements from at least one local sensor of the WTRU;
select a subset of candidate beams from the set of candidate beams based on the first local sensor measurements and the configuration information, responsive to a detection of a beam failure;
perform second local sensor measurements from at least one local sensor of the WTRU and radio measurements for candidate beams of the subset of candidate beams;
select a candidate beam from the subset of candidate beams, for which the second local sensor measurements and radio measurements meet at least one local sensor measurement threshold and at least one radio measurement threshold;
determine at least one random access channel (RACH) parameter for the selected candidate beam based on the configuration information received; and
send a RACH transmission on the selected candidate beam using the at least one RACH parameter.

27. The WTRU of claim 26, wherein the configuration information indicates at least one RACH parameter associated with each candidate beam of the set of candidate beams.

28. The WTRU of claim 26, wherein select a candidate beam from the subset of candidate beams comprises comparing the second local sensor measurements to the at least one local sensor measurement threshold and comparing the radio measurements to the at least one radio measurement threshold.

29. The WTRU of claim 26, wherein select the subset of candidate beams comprises the WTRU being configured to:
determine a current location and/or orientation of the WTRU based on the first local sensor measurements; and
select a zone of coverage from the plurality of zones of coverage based on the current location and/or orientation of the WTRU, and wherein the zone of coverage is associated with the subset of candidate beams.

30. The WTRU of claim 29, wherein determine a current location and/or orientation of the WTRU is based on second radio measurements.

31. The WTRU of claim 26, wherein the configuration information is received from the network node through a system information broadcast and/or through a dedicated signaling.

32. The WTRU of claim 26, wherein receive configuration information indicating a network coverage ensemble area comprises the WTRU being configured to:
send, to the network node, information comprising data from local sensors and further radio measurements, and wherein the network coverage ensemble area is based on the information.
